(19) United States
(12) Patent Application Publication
(10) Pub. No.: US 2007/0212139 A1
(43) Pub. Date: Sep. 13, 2007

(54) IMAGE FORMING APPARATUS, PROCESS UNIT, AND CLEANING DEVICE

(76) Inventors: Kenji Sugiura, Yokohama city (JP); Hidetoshi Yano, Yokohama city (JP); Osamu Naruse, Yokohama city (JP); Naomi Sugimoto, Kawasaki city (JP); Takuya Seshita, Hiratsuka city (JP); Yasuyuki Yamashita, Zama city (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/685,653

(22) Filed: Mar. 13, 2007

(30) Foreign Application Priority Data
Mar. 13, 2006 (JP) 2006-068085

(51) Int. Cl. G03G 21/00

(52) U.S. Cl. 399/353

(57) ABSTRACT

An image forming apparatus including an image carrier, a charger, an electrostatic latent image forming member, a developing member, a transferor, and a cleaning device. The electrostatic latent image forming member forms an electrostatic latent image on a surface of the image carrier charged by the charger. The developing member develops the electrostatic latent image formed on the surface of the image carrier with toner particles to form a toner image. The transferor transfers the toner image formed on the surface of the image carrier onto a recording medium. The cleaning device includes a fine particle supplier and an electrostatic cleaning mechanism. The fine particle supplier supplies fine particles onto the surface of the image carrier while an image forming operation is not performed. The electrostatic cleaning mechanism electrostatically removes a foreign substance adhered to the supplied fine particles from the surface of the image carrier.

### CROSS-REFERENCE TO RELATED APPLICATION

The present application is based on and claims priority to Japanese patent application No. 2006-068085 filed on Mar. 13, 2006 in the Japan Patent Office, the entire contents of which are hereby incorporated herein by reference.

### BACKGROUND OF THE INVENTION

1. Field of the Invention

Exemplary aspects of the present invention relate to an image forming apparatus, a process unit, and a cleaning device, and more particularly to an image forming apparatus, a process unit, and a cleaning device for removing a foreign substance from a surface of an image carrier.

2. Description of the Related Art

A related art image forming apparatus, such as a copying machine, a facsimile machine, a printer, or a multifunction printer having copying, printing, scanning, and facsimile functions, forms a toner image on a recording medium (e.g., a sheet) according to image data by an electrophotographic method. For example, a charger charges a surface of a photoconductor serving as an image carrier. An optical writer emits light on the charged surface of the photoconductor to form an electrostatic latent image on the photoconductor according to image data. The electrostatic latent image is developed with a developer (e.g., toner particles) to form a toner image on the photoconductor. The toner image is transferred from the photoconductor onto an intermediate transfer member and is further transferred onto a sheet. A fixing unit applies heat and pressure to the sheet bearing the toner image to fix the toner image on the sheet. Thus, the toner image is formed on the sheet.

After the toner image formed on the photoconductor is transferred onto the intermediate transfer member, a cleaner removes residual toner particles adhered to the surface of the photoconductor. The cleaner includes a cleaning member having a blade or brush shape. The cleaning member slidably contacts the surface of the photoconductor to remove residual toner particles from the surface of the photoconductor.

When the charger charges the surface of the photoconductor, an electric discharge is generated between the charger and the photoconductor, regardless of whether or not the charger is configured to contact the photoconductor to charge the surface of the photoconductor. Electric discharge generates a corona product (e.g., nitrogen oxides) and the corona product is adhered to the surface of the photoconductor. The corona product causes a hydrophilic substance to adhere to the surface of the photoconductor. When the hydrophilic substance is adhered to the surface of the photoconductor, an electric charge forming the electrostatic latent image moves on the surface of the photoconductor, generating image deletion. Image deletion forms a faulty, blurred, image on a sheet.

When the corona product is removed from the surface of the photoconductor, the faulty image may not be formed. However, the above-described cleaner for removing residual toner particles cannot properly remove the corona product. When the cleaning member of the cleaner slides on the surface of the photoconductor with an increased force to remove the corona product, the cleaning member may scrape the surface of the photoconductor and the cleaning member may easily wear.

To address the above-described problems, in one example of the related art image forming apparatus, charged fine particles (e.g., toner particles) are supplied onto the surface of the photoconductor while the image forming apparatus is not performing an image forming operation. The charged toner particles attract the corona product, so that the cleaning member sliding on the surface of the photoconductor removes the corona product together with the toner particles.

When toner particles are supplied onto the surface of the photoconductor while the image forming apparatus is not performing an image forming operation, the toner particles are not transferred onto the intermediate transfer member. Thus, the cleaner needs to remove almost all of the supplied toner particles. Namely, the cleaner needs to remove a greater amount of toner particles while the image forming apparatus is not performing an image forming operation than while the image forming apparatus is performing an image forming operation, resulting in an increased load on the cleaner. When the cleaner includes the cleaning member for sliding on the surface of the photoconductor, the cleaning member may not properly clean the surface of the photoconductor.

When toner particles are supplied onto the surface of the photoconductor while the image forming apparatus is not performing an image forming operation, the toner particles can be supplied onto the whole surface of the photoconductor irrespective of image data used for forming an electrostatic latent image. Thus, the corona product can be removed from the whole surface of the photoconductor.

A corona product may be adhered to toner particles supplied to develop an electrostatic latent image while the image forming apparatus performs an image forming operation. The cleaning member removes the corona product together with the supplied toner particles from the surface of the photoconductor. However, the cleaning member cannot remove the corona product adhered to a portion on the surface of the photoconductor, on which the electrostatic latent image is not formed. Namely, the cleaning member removes the corona product at the limited portion on the surface of the photoconductor, which is determined by image data by which the optical writer emits light onto the surface of the photoconductor to form an electrostatic latent image.

### BRIEF SUMMARY OF THE INVENTION

This specification describes below, an image forming apparatus according to an exemplary embodiment of the present invention. In one exemplary embodiment of the present invention, the image forming apparatus includes an image carrier, a charger, an electrostatic latent image forming member, a developing member, a transferor, and a cleaning device. The charger charges a surface of the image carrier. The electrostatic latent image forming member forms an electrostatic latent image on the charged surface of the image carrier. The developing member develops the electrostatic latent image formed on the surface of the image carrier with toner particles to form a toner image. The transferor transfers the toner image formed on the surface of the image carrier onto a recording medium. The cleaning device removes a foreign substance from the surface of the image carrier and includes a fine particle supplier and an electrostatic cleaning mechanism. The fine particle supplier supplies fine particles onto the surface of the image carrier while an image forming operation is not being performed. The electrostatic cleaning mechanism electrostatically removes the foreign substance, adhered to the supplied fine particles, from the surface of the image carrier.

This specification further describes below, a process unit according to an exemplary embodiment of the present invention. In one exemplary embodiment of the present invention, the process unit includes an image carrier, a cleaning device, and a support. The cleaning device removes a foreign substance from a surface of the image carrier and includes a fine particle supplier and an electrostatic cleaning mechanism. The fine particle supplier supplies fine particles onto the surface of the image carrier while an image forming operation is not being performed. The electrostatic cleaning mechanism electrostatically removes the foreign substance adhered to the supplied fine particles from the surface of the image carrier. The support supports the image carrier and the cleaning device.

This specification further describes below, a cleaning device according to an exemplary embodiment of the present invention. In one exemplary embodiment of the present invention, the cleaning device includes a fine particle supplier and an electrostatic cleaning mechanism. The fine particle supplier supplies fine particles onto the surface of the image carrier while an image forming operation is not being performed. The electrostatic cleaning mechanism electrostatically removes a foreign substance adhered to the supplied fine particles from the surface of the image carrier.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings, wherein:

FIG. 1 is a schematic view of an image forming apparatus according to an exemplary embodiment of the present invention;

FIG. 2 is a sectional view of a process unit included in the image forming apparatus shown in FIG. 1;

FIG. 3 is a sectional view of a cleaner included in the process unit shown in FIG. 2;

FIG. 4 is a flowchart of an exemplary corona product removal mode of the cleaner shown in FIG. 3;

FIG. 5 is a flowchart of another exemplary corona product removal mode of the cleaner shown in FIG. 3;

FIG. 6 is a flowchart of yet another exemplary corona product removal mode of the cleaner shown in FIG. 3;

FIG. 7 is a flowchart of yet another exemplary corona product removal mode of the cleaner shown in FIG. 3;

FIG. 8 is a flowchart of yet another exemplary corona product removal mode of the cleaner shown in FIG. 3;

FIG. 9A is an illustration of a grid pattern with image deletion;

FIG. 9B is an illustration of a grid pattern without image deletion;

FIG. 10 is a schematic view of an image forming apparatus according to another exemplary embodiment of the present invention;

FIG. 11 is a schematic view of a process unit included in an image forming apparatus according to yet another exemplary embodiment of the present invention;

FIG. 12 is a sectional view of a cleaner included in an image forming apparatus according to yet another exemplary embodiment of the present invention;

FIG. 13 is a sectional view of a cleaner included in an image forming apparatus according to yet another exemplary embodiment of the present invention;

FIG. 14 is a sectional view of a cleaner included in an image forming apparatus according to yet another exemplary embodiment of the present invention;

FIG. 15 is a sectional view of a cleaner included in an image forming apparatus according to yet another exemplary embodiment of the present invention;

FIG. 16 is a graph illustrating a relationship between a first transfer bias and a weight of residual toner particles remaining on a surface of a photoconductor included in the process unit shown in FIG. 2;

FIG. 17A is a sectional view of an exemplary photoconductor included in the process unit shown in FIG. 2;

FIG. 17B is a sectional view of another exemplary photoconductor included in the process unit shown in FIG. 2;

FIG. 17C is a sectional view of yet another exemplary photoconductor included in the process unit shown in FIG. 2;

FIG. 17D is a sectional view of yet another exemplary photoconductor included in the process unit shown in FIG. 2;

FIG. 18 is a sectional view of yet another exemplary photoconductor included in the process unit shown in FIG. 2;

FIG. 19A is an illustration showing structural formulas of a polyarylate resin included in the photoconductor shown in FIGS. 17A, 17B, 17C, 17D, and 18; and

FIG. 19B is an illustration showing another structural formulas of a polyarylate resin included in the photoconductor shown in FIGS. 17A, 17B, 17C, 17D, and 18.

### DETAILED DESCRIPTION OF THE INVENTION

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

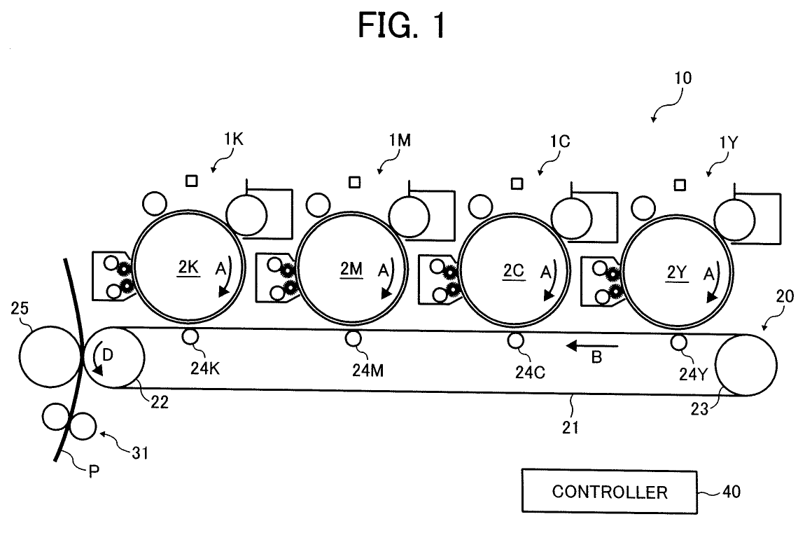

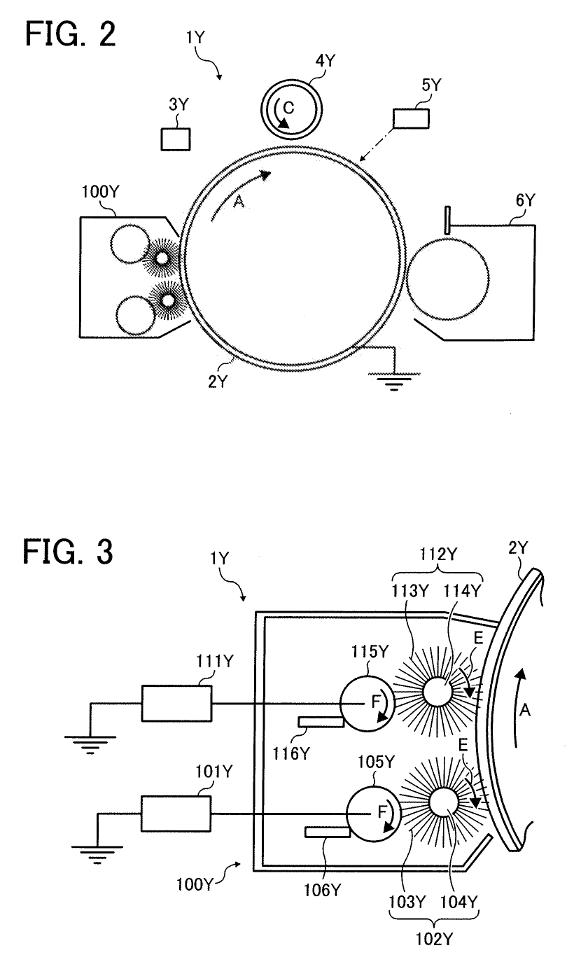

Referring now to the drawings, wherein like reference numerals designate identical or corresponding parts throughout the several views, in particular to FIGS. 1 and 2, an image forming apparatus 10 according to an exemplary embodiment of the present invention is explained.

As illustrated in FIG. 1, the image forming apparatus 10 includes process units 1Y, 1C, 1M, and 1K, a transfer unit 20, a registration roller pair 31, and a controller 40. The process units 1Y, 1C, 1M, and 1K include photoconductors 2Y, 2C, 2M, and 2K, respectively. The transfer unit 20 includes an intermediate transfer belt 21, a driving roller 22, a driven roller 23, four first transfer rollers 24Y, 24C, 24M, and 24K, and a second transfer roller 25.

As illustrated in FIG. 2, the process unit 1Y further includes a charging roller 4Y, an optical writer 5Y, a development unit 6Y, a cleaner 100Y, and a discharger 3Y.

The image forming apparatus 10 can be a copying machine, a facsimile machine, a printer, a multifunction printer having copying, printing, scanning, and facsimile functions, or the like. According to this non-limiting exemplary embodiment of the present invention, the image forming apparatus 10 functions as a color printer for printing a color image on a recording medium by an electrophotographic method.

The process units 1Y, 1C, 1M, and 1K form toner images in yellow, cyan, magenta, and black colors, respectively. The process units 1Y, 1C, 1M, and 1K are attachable to and detachable from the image forming apparatus 10. The process units 1Y, 1C, 1M, and 1K use toners of different colors from each other as a developer, but have a common structure. The controller 40 controls operations of the image forming apparatus 10.

Each of the photoconductors 2Y, 2C, 2M, and 2K, serving as an image carrier, is rotated by a driver (not shown) in a rotating direction A. As illustrated in FIG. 2, the charging roller 4Y, the optical writer 5Y, the development unit 6Y, the cleaner 100Y, and the discharger 3Y are disposed around the photoconductor 2Y.

The charging roller 4Y, serving as a charger, contacts the photoconductor 2Y or opposes the photoconductor 2Y with a predetermined gap provided between the charging roller 4Y and the photoconductor 2Y. A charging bias power source (not shown) applies a charging bias to the charging roller 4Y. While the charging roller 4Y rotates in a rotating direction C, the charging roller 4Y generates electric discharge between the charging roller 4Y and the photoconductor 2Y. Thus, the charging roller 4Y uniformly charges a surface of the photoconductor 2Y. The charging roller 4Y has a roller shape, however, a charging brush contacting the photoconductor 2Y may be used as the charger. A scorotron charger for charging the surface of the photoconductor 2Y without contacting the photoconductor 2Y may also be used as the charger.

The charging roller 4Y includes a roller (not shown) including a rigid, conductive material. The charging roller 4Y opposes the photoconductor 2Y with a small gap provided between the charging roller 4Y and the photoconductor 2Y. The length of the charging roller 4Y in a longitudinal direction (i.e., an axis line direction) of the charging roller 4Y is longer than the maximum sheet width that the image forming apparatus 10 can handle. For example, when the image forming apparatus 10 can feed an A4 size sheet in a landscape direction, the maximum sheet width is about 290 mm. The charging roller 4Y further includes gap rollers (not shown) disposed at both ends of the charging roller 4Y in the longitudinal direction of the charging roller 4Y. The gap rollers serve as insulating spacers and have a diameter greater than a diameter of a center portion of the charging roller 4Y in the longitudinal direction of the charging roller 4Y. The gap rollers contact non-image forming areas provided at both ends of the photoconductor 2Y in an axis line direction of the photoconductor 2Y. Thus, a small gap, in a range of from about 5 μm to about 100 μm and preferably in a range of from about 20 μm to about 65 μm, can be easily formed between the center portion of the charging roller 4Y and the photoconductor 2Y. According to this non-limiting exemplary embodiment, the small gap is about 55 μm.

The optical writer 5Y, serving as an electrostatic latent image forming member, emits and scans light onto the charged surface of the photoconductor 2Y. The light includes a laser beam and a LED (light-emitting diode) beam modulated based on image data sent from an external device (e.g., a personal computer). Thus, an electrostatic latent image corresponding to yellow image data is formed on the surface of the photoconductor 2Y.

The development unit 6Y, serving as a fine particle supplier and a developing member, develops the electrostatic latent image formed on the surface of the photoconductor 2Y with yellow toner. For example, the development unit 6Y causes yellow toner to adhere to the electrostatic latent image formed on the surface of the photoconductor 2Y according to a known technology. Thus, a yellow toner image is formed on the surface of the photoconductor 2Y. Similarly, in the process units 1C, 1M, and 1K (depicted in FIG. 1), cyan, magenta, and black toner images are formed on the surfaces of the photoconductors 2C, 2M, and 2K (depicted in FIG. 1) with cyan, magenta, and black toners, respectively.

As illustrated in FIG. 1, the transfer unit 20, serving as a transferor, is disposed under the process units 1Y, 1C, 1M, and 1K. The intermediate transfer belt 21, serving as an image carrier and a transfer member, is looped over the driving roller 22 and the driven roller 23. The driving roller 22 rotates in a rotating direction D. The rotating driving roller 22 rotates the intermediate transfer belt 21 in a rotating direction B.

The four first transfer rollers 24Y, 24C, 24M, and 24K oppose the photoconductors 2Y, 2C, 2M, and 2K via the intermediate transfer belt 21 to form first transfer nips between the intermediate transfer belt 21 and the photoconductors 2Y, 2C, 2M, and 2K, respectively. Each of the first transfer rollers 24Y, 24C, 24M, and 24K applies a first transfer bias having a polarity (e.g., the positive polarity) opposite to the polarity of a toner to an inner circumferential surface of the intermediate transfer belt 21. While the intermediate transfer belt 21 rotates in the rotating direction B, the yellow toner image formed on the surface of the photoconductor 2Y is transferred onto an outer circumferential surface of the intermediate transfer belt 21 at the first transfer nip formed between the intermediate transfer belt 21 and the photoconductor 2Y.

Similarly, in the process units 1C, 1M, and 1K, the cyan, magenta, and black toner images formed on the surfaces of the photoconductors 2C, 2M, and 2K are transferred onto the outer circumferential surface of the intermediate transfer belt 21 at the first transfer nips formed between the intermediate transfer belt 21 and the photoconductors 2C, 2M, and 2K, respectively. The yellow, cyan, magenta, and black toner images are transferred onto a common position on the outer circumferential surface of the intermediate transfer belt 21 while the common position passes the first transfer nips formed between the intermediate transfer belt 21 and the photoconductors 2Y, 2C, 2M, and 2K respectively. Namely, the yellow, cyan, magenta, and black toner images are superimposed on the outer circumferential surface of the intermediate transfer belt 21. Thus, superimposed toner images are formed on the outer circumferential surface of the intermediate transfer belt 21.

The second transfer roller 25 is disposed outside a loop formed by the intermediate transfer belt 21. The second transfer roller 25 opposes the driving roller 22 disposed inside the loop formed by the intermediate transfer belt 21 via the intermediate transfer belt 21 to form a second transfer nip between the intermediate transfer belt 21 and the second transfer roller 25. A power source (not shown) applies a second transfer bias to the second transfer roller 25.

As illustrated in FIG. 2, the cleaner 100Y removes residual toner remaining on the surface of the photoconductor 2Y after the yellow toner image formed on the surface of the photoconductor 2Y is transferred onto the outer circumferential surface of the intermediate transfer belt 21 (depicted in FIG. 1). The discharger 3Y (e.g., a discharging lamp) discharges the surface of the photoconductor 2Y. Thus, the photoconductor 2Y becomes ready for a next image forming operation.

As illustrated in FIG. 1, a paper tray (not shown) is disposed under the transfer unit 20. The paper tray loads a plurality of sheets P serving as a recording medium. An uppermost sheet P is fed to a sheet feeding path (not shown) at a predetermined time. The registration roller pair 31 is disposed at an end of the sheet feeding path. When the registration roller pair 31 nips the sheet P, the registration roller pair 31 stops rotating. The registration roller pair 31 feeds the sheet P toward the second transfer nip formed between the intermediate transfer belt 21 and the second transfer roller 25 at a proper time when the superimposed toner images formed on the outer circumferential surface of the intermediate transfer belt 21 are transferred onto the sheet P.

The second transfer roller 25, to which a second transfer bias is applied by the power source, and the driving roller 22, which is grounded, form a second transfer electric field between the second transfer roller 25 and the driving roller 22. The second transfer electric field and a pressure applied at the second transfer nip transfer the superimposed toner images formed on the outer circumferential surface of the intermediate transfer belt 21 onto the sheet P at the second transfer nip. Thus, a color toner image is formed on the sheet P.

A belt cleaner (not shown) opposes the driven roller 23 via the intermediate transfer belt 21. The belt cleaner removes residual toners remaining on the outer circumferential surface of the intermediate transfer belt 21 after the superimposed toner images formed on the outer circumferential surface of the intermediate transfer belt 21 are transferred onto the sheet P.

A fixing unit (not shown) is disposed above the second transfer nip. The fixing unit applies heat and pressure to the sheet P bearing the color toner image to fix the color toner image on the sheet P, by a known technology used in the image forming apparatus 10, using the electrophotographic method.

Each of the first transfer rollers 24Y, 24C, 24M, and 24K applies a first transfer bias having a polarity opposite to the polarity of a toner to the inner circumferential surface of the intermediate transfer belt 21. Therefore, the yellow, cyan, magenta, and black toners adhered to the electrostatic latent images formed on the surfaces of the photoconductors 2Y, 2C, 2M, and 2K may receive an electric charge having a polarity opposite to the polarity of the yellow, cyan, magenta, and black toners at the first transfer nips, respectively. Thus, the residual toners remaining on the surfaces of the photoconductors 2Y, 2C, 2M, and 2K after the yellow, cyan, magenta, and black toner images are transferred onto the outer circumferential surface of the intermediate transfer belt 21 may include toner particles charged with a normal polarity and toner particles charged with an opposite polarity.

In the image forming apparatus 10, the four process units 1Y, 1C, 1M, and 1K function as toner image forming members for forming toner images on the surfaces of the photoconductors 2Y, 2C, 2M, and 2K serving as image carriers, respectively. A combination of the four process units 1Y, 1C, 1M, and 1K and the transfer unit 20 functions as a toner image forming member for forming a toner image on the outer circumferential surface of the intermediate transfer belt 21 serving as an image carrier.

According to this non-limiting exemplary embodiment, yellow, cyan, magenta, and black toner images formed on the surfaces of the photoconductors 2Y, 2C, 2M, and 2K, respectively, are transferred onto the outer circumferential surface of the intermediate transfer belt 21, and further transferred onto a sheet P. However, the image forming apparatus 10 may have a structure in which yellow, cyan, magenta, and black toner images formed on the surfaces of the photoconductors 2Y, 2C, 2M, and 2K, respectively, are transferred directly onto a sheet P.

FIG. 3 is a sectional view of the cleaner 100Y. As illustrated in FIG. 3, the cleaner 100Y includes a first cleaning brush 102Y, a second cleaning brush 112Y, a first collecting roller 105Y, a second collecting roller 115Y, a first roller power source 101Y, a second roller power source 111Y, a first scraper 106Y, and a second scraper 116Y. The first cleaning brush 102Y includes a first shaft 104Y and a first nap 103Y. The second cleaning brush 112Y includes a second shaft 114Y and a second nap 113Y. The cleaner 100Y further includes a conveying coil (not shown). The first cleaning brush 102Y, the second cleaning brush 112Y, the first collecting roller 105Y, the second collecting roller 115Y, the first roller power source 101Y, and the second roller power source 111Y form an electrostatic cleaning mechanism for electrostatically removing residual toner particles from the surface of the photoconductor 2Y (depicted in FIG. 2). The cleaner 100Y and the development unit 6Y (depicted in FIG. 2) form a cleaning device for cleaning the surface of the photoconductor 2Y.

The first cleaning brush 102Y, serving as a first cleaning member, and the second cleaning brush 112Y, serving as a second cleaning member, rotate in a rotating direction E to slide on the surface of the photoconductor 2Y to remove toner particles from the surface of the photoconductor 2Y. However, the first cleaning brush 102Y and the second cleaning brush 112Y may be positioned close to the surface of the photoconductor 2Y. The first collecting roller 105Y and the second collecting roller 115Y contact the first cleaning brush 102Y and the second cleaning brush 112Y, respectively. The first roller power source 101Y and the second roller power source 111Y supply power to the first collecting roller 105Y and the second collecting roller 115Y, respectively. The first scraper 106Y and the second scraper 116Y contact the first collecting roller 105Y and the second collecting roller 115Y, respectively. The first shaft 104Y and the second shaft 114Y extend in parallel to an axial direction of the photoconductor 2Y. The first nap 103Y and the second nap 113Y are mounted on outer circumferential surfaces of the first shaft 104Y and the second shaft 114Y, respectively.

Bearings (not shown) are provided on both side walls of a casing (not shown) of the cleaner 100Y. The bearings rotatably support the first shaft 104Y and the second shaft 114Y. Namely, the first shaft 104Y and the second shaft 114Y are rotatably held in the casing. While the first shaft 104Y and the second shaft 114Y rotate, the first nap 103Y and the second nap 113Y slide on the surface of the photoconductor 2Y. The first nap 103Y and the second nap 113Y scrape and receive residual toner particles from the surface of the photoconductor 2Y. Namely, the first cleaning brush 102Y and the second cleaning brush 112Y move toner particles from the surface of the photoconductor 2Y to surfaces of the first cleaning brush 102Y and the second cleaning brush 112Y (i.e., the first nap 103Y and the second nap 113Y), respectively. Thus, the first cleaning brush 102Y and the second cleaning brush 112Y function as cleaning members for removing toner particles from the surface of the photoconductor 2Y.

The first nap 103Y and the second nap 113Y include a conductive fiber providing a high resistance. For example, the conductive fiber provides a high resistance being equivalent to a level at which the first nap 103Y and the second nap 113Y can at least carry an electric charge or being equivalent to a resistance level on the surface of the intermediate transfer belt 21 (depicted in FIG. 1). Examples of the conductive fiber providing the high resistance include a fiber including a material obtained by adding a conductive material (e.g., carbon and/or the like) to a resin (e.g., polyester, nylon, acryl, and/or the like). However, the conductive fiber providing the high resistance may include other material as long as the material is a conductive fiber providing the high resistance. The conductive fiber may be produced by adding a conductive property to a material included in a fiber. Alternatively, the conductive fiber may be produced by coating a conductive material on an insulating fiber or by inserting a conductive material into an insulating fiber. Further, in another method, the conductive fiber may be produced by adding a conductive property to a fiber. When a surface of a fiber is coated with an insulating material, the fiber can include a material having an increased conductive property (e.g., a metal fiber) instead of a material having a high resistance, because the surface of the fiber can carry an electric charge.

Each of the first collecting roller 105Y and the second collecting roller 115Y includes a base (not shown) and a shaft (not shown). The base includes a metal (e.g., stainless steel and/or the like) and/or a resin material having an increased conductive property. Bearings (not shown) provided on the casing support the shaft protruding from both ends of the base in a longitudinal direction of the base. The first collecting roller 105Y and the second collecting roller 115Y rotate in a rotating direction F to contact the first cleaning brush 102Y and the second cleaning brush 112Y, respectively. The first collecting roller 105Y and the second collecting roller 115Y function as electrode members for contacting the first cleaning brush 102Y and the second cleaning brush 112Y, respectively. To decrease a surface friction coefficient, fluoroplastic (e.g., PFA (perfluoroalkoxy) and/or the like) may be applied on the base. Alternatively, eutectoid plating of fluoroplastic and metal may be performed. The base may include a conductive rubber and/or a conductive resin. An insulating material may cover the base. For example, an insulating surface layer including fluoroplastic and having a thickness of about 10 μm may be formed on the base.

The first roller power source 101Y and the second roller power source 111Y apply bias voltages, having different polarities from each other, to the first collecting roller 105Y and the second collecting roller 115Y via leads and contacts (not shown), respectively. According to this non-limiting exemplary embodiment, the first roller power source 101Y applies a bias voltage having a positive polarity to the first collecting roller 105Y. The second roller power source 111Y applies a bias voltage having a negative polarity to the second collecting roller 115Y.

The first scraper 106Y and the second scraper 116Y are disposed near lower portions of the first collecting roller 105Y and the second collecting roller 115Y, respectively. Each of the first scraper 106Y and the second scraper 116Y is cantilevered at one end. The other end (i.e., a free end) of the first scraper 106Y contacts the first collecting roller 105Y. The other end (i.e., a free end) of the second scraper 116Y contacts the second collecting roller 115Y. When the surfaces of the first collecting roller 105Y and the second collecting roller 115Y include a metal material, the first scraper 106Y and the second scraper 116Y preferably include a material having an increased friction resistance (e.g., a nylon sheet, a rubber blade, and/or the like). When the surfaces of the first collecting roller 105Y and the second collecting roller 115Y include a nonmetal material (e.g., a conductive rubber, a conductive resin, and/or the like), the first scraper 106Y and the second scraper 116Y preferably include a metal.

The first cleaning brush 102Y rotates to contact the photoconductor 2Y at a first cleaning position, further rotates to contact the first collecting roller 105Y at a first collecting position, and further rotates to contact the photoconductor 2Y at the first cleaning position again. The second cleaning brush 112Y rotates to contact the photoconductor 2Y at a second cleaning position, further rotates to contact the second collecting roller 115Y at a second collecting position, and further rotates to contact the photoconductor 2Y at the second cleaning position again. At the first collecting position, an electric discharge is generated between the first collecting roller 105Y, having a positive polarity, and the first nap 103Y, electrically floated and including a conductive material providing a high resistance. At the second collecting position, an electric discharge is generated between the second collecting roller 115Y, having a negative polarity, and the second nap 113Y, electrically floated and including a conductive material providing a high resistance. The electric discharge causes the first nap 103Y and the second nap 113Y to carry an electric charge.

The first nap 103Y carries a positive charge because the first roller power source 101Y applies a voltage having a positive polarity to the first collecting roller 105Y. The second nap 113Y carries a negative charge because the second roller power source 111Y applies a voltage having a negative polarity to the second collecting roller 115Y.

When residual toner particles remaining on the surface of the rotating photoconductor 2Y reach the first cleaning position where the first cleaning brush 102Y contacts the photoconductor 2Y, the rotating first cleaning brush 102Y sliding on the surface of the photoconductor 2Y and an electrostatic action of an electric charge having a positive polarity carried by the first nap 103Y removes negatively charged toner particles from the surface of the photoconductor 2Y. Namely, the negatively charged toner particles move from the photoconductor 2Y onto the first nap 103Y.

The electric charge having the positive polarity carried by the first nap 103Y electrostatically attracts the negatively charged toner particles from the surface of the photoconductor 2Y at the first cleaning position. The rotating first cleaning brush 102Y conveys the negatively charged toner particles to the first collecting position where the first cleaning brush 102Y contacts the first collecting roller 105Y. When the negatively charged toner particles reach the first collecting position, a voltage having a positive polarity applied to the first collecting roller 105Y electrostatically moves the negatively charged toner particles from the first nap 103Y to the surface of the first collecting roller 105Y. Thus, the first collecting roller 105Y collects the negatively charged toner particles.

The rotating first collecting roller 105Y conveys the collected negatively charged toner particles to a first scraping position, where the first collecting roller 105Y contacts the first scraper 106Y. When the collected negatively charged toner particles reach the first scraping position, the first scraper 106Y, sliding on the surface of the first collecting roller 105Y, scrapes the collected negatively charged toner particles from the surface of the first collecting roller 105Y. The scraped toner particles fall to a toner exhausting member (e.g., a conveying coil (not shown)) disposed under the first collecting roller 105Y. The conveying coil rotates to convey and output the scraped toner particles to the outside of the cleaner 100Y.

Non-charged toner particles do not have an electrostatically attracting force. Therefore, the rotating first cleaning brush 102Y sliding on the surface of the photoconductor 2Y can easily remove the non-charged toner particles from the surface of the photoconductor 2Y. The non-charged toner particles fall from the rotating first cleaning brush 102Y to the toner exhausting member and are collected into the toner exhausting member.

Positively charged toner particles remaining on the surface of the photoconductor 2Y are not removed by the first cleaning brush 102Y, even when the positively charged toner particles remaining on the rotating photoconductor 2Y reach the first cleaning position. Thus, the positively charged toner particles remaining on the rotating photoconductor 2Y reach the second cleaning position where the second cleaning brush 112Y contacts the photoconductor 2Y. When the positively charged toner particles remaining on the surface of the rotating photoconductor 2Y reach the second cleaning position, the rotating second cleaning brush 112Y sliding on the surface of the photoconductor 2Y and an electrostatic action of an electric charge having the negative polarity carried by the second nap 113Y remove the positively charged toner particles from the surface of the photoconductor 2Y. Thus, the positively charged toner particles move from the photoconductor 2Y onto the second nap 113Y.

The electric charge having the negative polarity, which is electrostatically carried by the second nap 113Y, attracts the positively charged toner particles from the surface of the photoconductor 2Y at the second cleaning position. The rotating second cleaning brush 112Y conveys the positively charged toner particles to the second collecting position where the second cleaning brush 112Y contacts the second collecting roller 115Y. When the positively charged toner particles reach the second collecting position, a voltage having the negative polarity applied to the second collecting roller 115Y electrostatically moves the positively charged toner particles from the second nap 113Y to the surface of the second collecting roller 115Y. Thus, the second collecting roller 115Y collects the positively charged toner particles.

The rotating second collecting roller 115Y conveys the collected positively charged toner particles to a second scraping position, where the second collecting roller 115Y contacts the second scraper 116Y. When the collected positively charged toner particles reach the second scraping position, the second scraper 116Y, sliding on the surface of the second collecting roller 115Y, scrapes the collected positively charged toner particles from the surface of the second collecting roller 115Y. The scraped toner particles fall to a toner exhausting member (e.g., a conveying coil (not shown)) disposed under the second collecting roller 115Y. The conveying coil rotates to convey and output the scraped toner particles to the outside of the cleaner 100Y.

According to this non-limiting exemplary embodiment, the first nap 103Y is positively charged before residual toner particles remaining on the surface of the rotating photoconductor 2Y reach the first cleaning position. Thus, negatively charged toner particles are removed by the first nap 103Y from the surface of the photoconductor 2Y. The second nap 113Y is negatively charged before residual toner particles remaining on the surface of the rotating photoconductor 2Y reach the second cleaning position. Thus, positively charged toner particles are removed by the second nap 113Y from the surface of the photoconductor 2Y. Namely, the first cleaning brush 102Y and the second cleaning brush 112Y can electrostatically attract toner particles having a normal polarity (i.e., the negative polarity) and toner particles having an opposite polarity (i.e., the positive polarity) from the surface of the photoconductor 2Y, respectively.

The first nap 103Y and the second nap 113Y include a fiber providing a high resistance and/or an insulating material covering a fiber providing an increased conductive property, so as to generate electric discharge between the first nap 103Y and the first collecting roller 105Y and between the second nap 113Y and the second collecting roller 115Y, respectively. When an electric discharge is properly generated without the above-described fibers, the first nap 103Y and the second nap 113Y may include an insulating material. For example, when the first shaft 104Y includes a metal material and an electric discharge is generated between the first shaft 104Y and the first collecting roller 105Y, an electric discharge is also generated between the first nap 103Y and the first collecting roller 105Y. In this case, the first nap 103Y may include an insulating material.

In the cleaner 100Y, electric discharge may be generated between the first cleaning brush 102Y and the photoconductor 2Y and between the second cleaning brush 112Y and the photoconductor 2Y, in accordance with an amount of electric charge carried by the first cleaning brush 102Y and the second cleaning brush 112Y, so as to discharge the photoconductor 2Y. In this case, the discharger 3Y (depicted in FIG. 2) can be eliminated to manufacture the cleaner 100Y to be compact in size and at decreased costs.

As illustrated in FIG. 3, the surface of the photoconductor 2Y and the surface of the first cleaning brush 102Y move in opposite directions to each other at the first cleaning position. The surface of the photoconductor 2Y and the surface of the second cleaning brush 112Y move in opposite directions to each other at the second cleaning position. However, the surface of the photoconductor 2Y and the surface of the first cleaning brush 102Y may move in a common direction at the first cleaning position. The surface of the photoconductor 2Y and the surface of the second cleaning brush 112Y may move in a common direction at the second cleaning position.

The surface of the first cleaning brush 102Y and the surface of the first collecting roller 105Y move in opposite directions to each other at the first collecting position. The surface of the second cleaning brush 112Y and the surface of the second collecting roller 115Y move in opposite directions to each other at the second collecting position. However, the surface of the first cleaning roller 102Y and the surface of the first collecting roller 105Y may move in a common direction at the first collecting position. The surface of the second cleaning brush 112Y and the surface of the second collecting roller 115Y may move in a common direction at the second collecting position.

The first cleaning brush 102Y and the second cleaning brush 112Y rotate in the rotating direction E. The first cleaning brush 102Y and the second cleaning brush 112Y can also swing in an axial direction of the first cleaning brush 102Y and the second cleaning brush 112Y, so as to prevent or reduce a decrease in cleaning performance caused by a substantial amount of toner particles being attracted to a specific part on the first cleaning brush 102Y and the second cleaning brush 112Y. Namely, when the surface of the rotating photoconductor 2Y touches the surfaces of the first cleaning brush 102Y and the second cleaning brush 112Y in varied directions in an axial direction of the first cleaning brush 102Y and the second cleaning brush 112Y, residual toner particles being in a substantial amount and remaining on a specific part of the surface of the photoconductor 2Y in the axial direction of the first cleaning brush 102Y and the second cleaning brush 112Y can be dispersed in the axial direction of the first cleaning brush 102Y and the second cleaning brush 112Y when the residual toner particles touch the first cleaning brush 102Y and the second cleaning brush 112Y.

To determine the toner density of a two-component developer including toner particles and magnetic carriers, a reference patch toner image may be formed on the surface of the photoconductor 2Y so that an optical sensor (not shown) can detect the reference patch toner image. In this case, the surface of the photoconductor 2Y needs to be cleaned to remove a substantial amount of toner particles forming the reference patch toner image. When a sheet P is jammed after a toner image is formed on the surface of the photoconductor 2Y, toner particles forming the toner image need to be removed without being transferred onto the intermediate transfer belt 21 (depicted in FIG. 1) after the jammed sheet is removed. Namely, the surface of the photoconductor 2Y needs to be cleaned to remove a substantial amount of toner particles forming the toner image. In the image forming apparatus 10 (depicted in FIG. 1), the bias voltages applied by the first roller power source 101Y and the second roller power source 111Y can be adjusted (the bias voltages can be increased, for example) to effectively remove the substantial amount of toner particles from the surface of the photoconductor 2Y.

The first nap 103Y and the second nap 113Y include a conductive polyester, for example. Strings of the first nap 103Y and the second nap 113Y have a resistance of about 10⁸ Ω·cm, a density of about 100,000 strings per square inch, and a length of about 5 mm, for example.

The first collecting roller 105Y and the second collecting roller 115Y include a stainless steel and have a diameter of about 10 mm, for example.

The first scraper 106Y and the second scraper 116Y include a polyurethane rubber and contact the first collecting roller 105Y and the second collecting roller 115Y, respectively, at an angle of about 20 degrees with an engagement of about 1 mm, for example.

The first roller power source 101Y applies a voltage of about +300 V to the first collecting roller 105Y, for example. The second roller power source 111Y applies a voltage of about −350 V to the second collecting roller 115Y.

Cleaners (not shown) included in the process units 1C, 1M, and 1K (depicted in FIG. 1) have a structure common to the cleaner 100Y.

According to this non-limiting exemplary embodiment, the photoconductor 2Y has a drum shape. However, the photoconductor 2Y may have other shapes, for example, an endless belt shape. The cleaner 100Y is also applicable to a belt cleaner (not shown) for cleaning the outer circumferential surface of the intermediate transfer belt 21 (depicted in FIG. 1). The intermediate transfer belt 21 may have properties, such as electric properties (e.g., volume resistivity, surface resistivity, and the like), thickness, the number of layers (e.g., a single layer, double layers, or three or more layers), and materials, which can be properly selected according to image forming conditions and/or the like.

Nowadays, an image forming apparatus generally uses a reversal development method in which the surface of a photoconductor and a toner are negatively charged. However, the cleaner 100Y may also be included in an image forming apparatus using a reversal development method in which a toner is positively charged or a normal development method in which a toner is positively or negatively charged. The cleaner 100Y may also be included in an image forming apparatus using a one-component developer including toner particles or a two-component developer including toner particles and magnetic carriers.

As illustrated in FIG. 2, when electric discharge is generated between the charging roller 4Y and the photoconductor 2Y to uniformly charge the surface of the photoconductor 2Y, a foreign substance, that is, a corona product (e.g., a nitrogen oxide and/or the like), is generated and adhered to the surface of the photoconductor 2Y. The image forming apparatus 10 (depicted in FIG. 1) executes a corona product removal mode for removing the corona product while an image forming operation is not being performed.

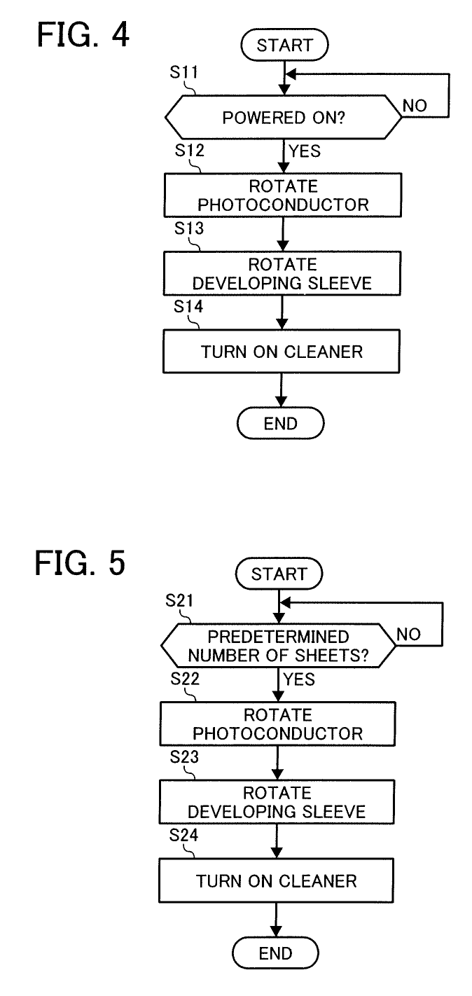

Referring to FIG. 4, the following describes an exemplary corona product removal mode. In step S11, the controller 40 (depicted in FIG. 1) determines whether or not the image forming apparatus 10 (depicted in FIG. 1) is powered on. When the image forming apparatus 10 is powered on (i.e., if YES is selected in step S11), the controller 40 drives a driver (not shown) to rotate the photoconductor 2Y (depicted in FIG. 2) while a charging bias of a charger (not shown), which includes the charging roller 4Y (depicted in FIG. 2) and a charging bias power source (not shown), is turned off, in step S12. In step S13, the controller 40 drives the development unit 6Y (depicted in FIG. 2) to rotate a developing sleeve (not shown) included in the development unit 6Y. The rotating developing sleeve causes toner particles to adhere onto the surface of the photoconductor 2Y, so that a corona product moves from the surface of the photoconductor 2Y to the surfaces of the toner particles for about 60 seconds. In step S14, the controller 40 turns on the cleaner 100Y (depicted in FIG. 2). The first cleaning brush 102Y (depicted in FIG. 3) and the second cleaning brush 112Y (depicted in FIG. 3) scrape the corona product together with the toner particles from the surface of the photoconductor 2Y. A voltage of about 0 V may be applied to the developing sleeve. However, a direct-current voltage may be applied to cause toner particles in a proper amount to adhere onto the surface of the photoconductor 2Y. The time period for which the rotating developing sleeve causes toner particles to adhere onto the surface of the photoconductor 2Y is not limited to about 60 seconds and may be a time period needed for the photoconductor 2Y to rotate for one cycle, for example. According to this non-limiting exemplary embodiment, the development unit 6Y supplies toner particles to the surface of the photoconductor 2Y. However, fine particles other than toner particles may be supplied to the surface of the photoconductor 2Y to remove the corona product from the surface of the photoconductor 2Y.

When the corona product removal mode is finished, a process control is performed as needed to start an image forming operation.

The image forming apparatus 10 executes the corona product removal mode while an image forming operation is not being performed. Thus, toner particles can be supplied onto the whole surface of the photoconductor 2Y irrespective of image data. The toner particles can attract a corona product on the whole surface of the photoconductor 2Y. The first cleaning brush 102Y and the second cleaning brush 112Y remove the toner particles to which the corona product is adhered. As a result, the corona product can be removed from the whole surface of the photoconductor 2Y.

The toner particles supplied onto the whole surface of the photoconductor 2Y in the corona product removal mode are not used for forming a toner image. Therefore, toner particles in an amount needed for forming a halftone image are supplied. For example, toner particles in an amount of a quarter of toner particles needed for forming a solid image are supplied onto the whole surface of the photoconductor 2Y.

As described above, the amount of toner particles supplied onto the surface of the photoconductor 2Y in the corona product removal mode is smaller than the amount of toner particles supplied onto the surface of the photoconductor 2Y for forming a solid image. However, the amount of toner particles reaching the first cleaning position and the second cleaning position in the corona product removal mode is greater than the amount of toner particles supplied for forming a solid image that reach the first cleaning position and the second cleaning position.

The toner particles supplied for forming a solid image that reach the first cleaning position and the second cleaning position are toner particles not transferred at the first transfer nip formed between the intermediate transfer belt 21 and the photoconductor 2Y (depicted in FIG. 1). About 95 percent or more, at least about 90 percent or more, of the toner particles are usually transferred at the first transfer nip. Namely, about one-tenth, at most, of toner particles supplied onto the surface of the photoconductor 2Y for forming a solid image reaches the first cleaning position and the second cleaning position. The amount of toner particles supplied onto the surface of the photoconductor 2Y in the corona product removal mode is about one-fourth of the amount of toner particles supplied onto the surface of the photoconductor 2Y for forming a solid image. However, the toner particles supplied in the corona product removal mode reach the first cleaning position and the second cleaning position without being transferred onto the intermediate transfer belt 21. Thus, the amount of toner particles reaching the first cleaning position and the second cleaning position in the corona product removal mode is greater than the amount of toner particles supplied for forming a solid image that reach the first cleaning position and the second cleaning position.

In the corona product removal mode, more toner particles need to be removed from the surface of the photoconductor 2Y than when forming a solid image. Thus, a greater load is applied to a cleaner for cleaning the surface of the photoconductor 2Y. When the cleaner is configured to slide on the surface of the photoconductor 2Y, a faulty cleaning may occur. As illustrated in FIG. 3, in the cleaner 100Y, electric charges carried by the first nap 103Y and the second nap 113Y electrostatically remove toner particles from the surface of the photoconductor 2Y, resulting in effective cleaning of the photoconductor 2Y.

The smaller the particle size of toner particles, the greater the amount of corona product removed with respect to the amount of toner particles supplied onto the surface of the photoconductor 2Y. Namely, the smaller the particle size of toner particles, the greater the surface area of toner particles with respect to the volume of toner particles.

According to this non-limiting exemplary embodiment, toner particles have an average particle size of about 5.0 μm or smaller, and preferably about 4.5 μm. The particle size of toner particles is measured with a particle size analyzer, such as a Coulter counter TA-II available from Beckman Coulter, Inc. having an aperture diameter of about 100 μm.

In the corona product removal mode, toner particles in an amount greater than when forming a solid image need to be removed from the surface of the photoconductor 2Y. Therefore, the first roller power source 101Y and the second roller power source 111Y may apply higher voltages to the first collecting roller 105Y and the second collecting roller 115Y, respectively. In the corona product removal mode, toner particles reaching the first cleaning position and the second cleaning position are not affected by a first transfer bias applied by the first transfer roller 24Y (depicted in FIG. 1). Therefore, almost all of the toner particles have a normal polarity (i.e., the negative polarity). To remove toner particles having the negative polarity as much as possible, the first roller power source 101Y may apply a higher voltage to the first collecting roller 105Y. Almost all of the toner particles to be removed have the negative polarity. Therefore, the second roller power source 111Y may apply a voltage having the positive polarity to the second collecting roller 115Y. Thus, both the first cleaning brush 102Y and the second cleaning brush 112Y may remove the toner particles having the negative polarity.

Referring to FIG. 5, the following describes another exemplary corona product removal mode. As illustrated in FIG. 5, the image forming apparatus 10 (depicted in FIG. 1) executes the corona product removal mode, not when the image forming apparatus 10 is powered on, but whenever an image is formed on a predetermined number of sheets P.

The image forming apparatus 10 counts the number of sheets P on which an image is formed while the image forming apparatus 10 performs image forming operations. In step S21, the controller 40 (depicted in FIG. 1) determines whether or not an image is formed on a predetermined number of sheets P (e.g., 200 sheets). When an image is formed on the predetermined number of sheets P (i.e., if YES is selected in step S21), the controller 40 rotates the photoconductor 2Y (depicted in FIG. 2) while a charging bias is turned off, in step S22. In step S23, the controller 40 rotates the developing sleeve included in the development unit 6Y (depicted in FIG. 2). The rotating developing sleeve causes toner particles to adhere onto the surface of the photoconductor 2Y, so that a corona product moves from the surface of the photoconductor 2Y to the surfaces of the toner particles. In step S24, the controller 40 turns on the cleaner 100Y (depicted in FIG. 2). The first cleaning brush 102Y (depicted in FIG. 3) and the second cleaning brush 112Y (depicted in FIG. 3) scrape the corona product together with the toner particles from the surface of the photoconductor 2Y.

When the controller 40 determines that an image is not formed on the predetermined number of sheets P (i.e., if NO is selected in step S21), the number of sheets P on which an image is formed is counted. When the corona product removal mode is finished, the counted number of sheets P on which an image is formed is reset.

When the image forming apparatus 10 is configured to execute the corona product removal mode whenever an image is formed on a predetermined number of sheets P, a substance adhered to the surface of the photoconductor 2Y can be periodically removed, properly preventing an image of a decreased quality from being formed on a sheet P for a long time period.

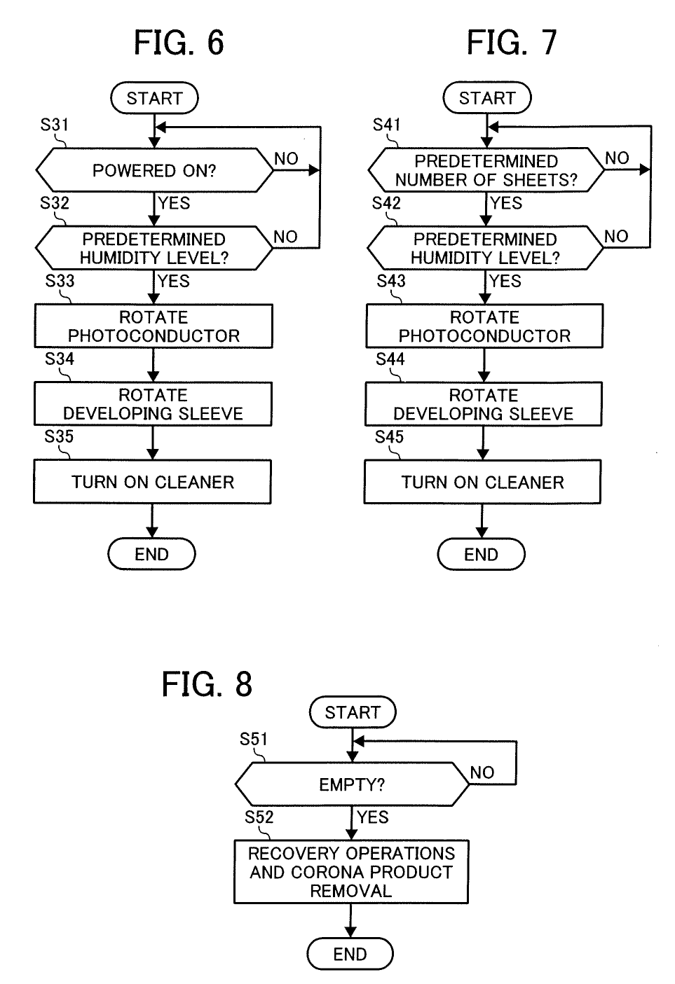

Referring to FIG. 6, the following describes yet another exemplary corona product removal mode. As illustrated in FIG. 6, the image forming apparatus 10 (depicted in FIG. 1) executes the corona product removal mode, when the image forming apparatus 10 is powered on and a humidity reaches a predetermined level.

In step S31, the controller 40 (depicted in FIG. 1) determines whether or not the image forming apparatus 10 is powered on. When the controller 40 determines that the image forming apparatus 10 is powered on (i.e., if YES is selected in step S31), a humidity detector (not shown) detects the humidity in step S32. When the humidity reaches a predetermined level (i.e., if YES is selected in step S32), the controller 40 rotates the photoconductor 2Y (depicted in FIG. 2) while a charging bias is turned off, in step S33. In step S34, the controller 40 rotates the developing sleeve included in the development unit 6Y (depicted in FIG. 2). The rotating developing sleeve causes toner particles to adhere onto the surface of the photoconductor 2Y, so that a corona product moves from the surface of the photoconductor 2Y to the surfaces of the toner particles. In step S35, the controller 40 turns on the cleaner 100Y (depicted in FIG. 2). The first cleaning brush 102Y (depicted in FIG. 3) and the second cleaning brush 112Y (depicted in FIG. 3) scrape the corona product together with the toner particles from the surface of the photoconductor 2Y.

Under a high humidity, the electric resistance on the surface of the photoconductor 2Y decreases. Image deletion may easily appear on a portion on the surface of the photoconductor 2Y onto which a corona product is adhered. According to this non-limiting exemplary embodiment, the humidity detector detects the humidity when the image forming apparatus 10 is powered on. When the humidity reaches a predetermined level (e.g., 75 percent), the image forming apparatus 10 executes the corona product removal mode. Namely, the image forming apparatus 10 can remove the corona product from the surface of the photoconductor 2Y in accordance with a change in environmental conditions, for example, a condition in which an image of decreased quality may be easily formed. The image forming apparatus 10 consumes a substantial amount of toner particles in the corona product removal mode. However, the image forming apparatus 10 can consume a decreased amount of toner particles when the image forming apparatus 10 is configured to execute the corona product removal mode only when the humidity reaches a predetermined level.

The humidity detector includes a humidity sensor. The humidity sensor is disposed at a position far from a fixing unit (not shown), for example, in the image forming apparatus 10.

Referring to FIG. 7, the following describes yet another exemplary corona product removal mode. As illustrated in FIG. 7, the image forming apparatus 10 (depicted in FIG. 1) executes the corona product removal mode when an image is formed on a predetermined number of sheets P and the humidity reaches a predetermined level.

The image forming apparatus 10 counts the number of sheets P on which an image is formed while the image forming apparatus 10 performs image forming operations. In step S41, the controller 40 (depicted in FIG. 1) determines whether or not an image is formed on a predetermined number of sheets P (e.g., 200 sheets). When an image is formed on the predetermined number of sheets P (i.e., if YES is selected in step S41), a humidity detector (not shown) detects the humidity in step S42. When the humidity reaches a predetermined level (i.e., if YES is selected in step S42), the controller 40 rotates the photoconductor 2Y (depicted in FIG. 2) while a charging bias is turned off, in step S43. In step S44, the controller 40 rotates the developing sleeve included in the development unit 6Y (depicted in FIG. 2). The rotating developing sleeve causes toner particles to adhere onto the surface of the photoconductor 2Y, so that a corona product moves from the surface of the photoconductor 2Y to the surfaces of the toner particles. In step S45, the controller 40 turns on the cleaner 100Y (depicted in FIG. 2). The first cleaning brush 102Y (depicted in FIG. 3) and the second cleaning brush 112Y (depicted in FIG. 3) scrape the corona product together with the toner particles from the surface of the photoconductor 2Y.

Under a high humidity, the electric resistance on the surface of the photoconductor 2Y decreases. Image deletion may easily appear on a portion on the surface of the photoconductor 2Y onto which a corona product is adhered. According to this non-limiting exemplary embodiment, the humidity detector detects the humidity when an image is formed on the predetermined number of sheets P. When the humidity reaches a predetermined level (e.g., 75 percent), the image forming apparatus 10 executes the corona product removal mode. Namely, the image forming apparatus 10 can remove the corona product from the surface of the photoconductor 2Y in accordance with a change in environmental conditions, for example, a condition in which an image of decreased quality may be easily formed. The image forming apparatus 10 consumes a substantial amount of toner particles in the corona product removal mode. However, the image forming apparatus 10 can consume a decreased amount of toner particles when the image forming apparatus 10 is configured to execute the corona product removal mode only when the humidity reaches a predetermined level.

The humidity detector includes a humidity sensor. The humidity sensor is disposed at a position far from a fixing unit (not shown), for example, in the image forming apparatus 10.

Referring to FIG. 8, the following describes yet another exemplary corona product removal mode. As illustrated in FIG. 8, the image forming apparatus 10 (depicted in FIG. 1) executes the corona product removal mode when a toner container (not shown) becomes empty and thereby is replaced with a new one.

For example, when a toner density sensor (not shown) included in the development unit 6Y (depicted in FIG. 2) detects that the toner container (e.g., a toner bottle) is empty, a user replaces the toner bottle with a new one. According to this non-limiting exemplary embodiment, the image forming apparatus 10 executes the corona product removal mode while the toner bottle is replaced with a new one. In this case, at least the development unit 6Y, the photoconductor 2Y (depicted in FIG. 2), and the cleaner 100Y (depicted in FIG. 2) are operable while the user replaces the toner bottle with a new one.

As illustrated in FIG. 8, the toner density sensor detects whether or not the toner bottle is empty in step S51. When the toner density sensor detects that the toner bottle is empty (i.e., if YES is selected in step S51), the image forming apparatus 10 performs recovery operations (e.g., replacing the toner bottle with a new one and supplying toner particles from the new toner bottle to the development unit 6Y) in step S52. While performing the recovery operations, the image forming apparatus 10 executes the corona product removal mode simultaneously in step S52. In the corona product removal mode, the controller 40 (depicted in FIG. 1) rotates the photoconductor 2Y while a charging bias is turned off. The controller 40 rotates the developing sleeve included in the development unit 6Y. The rotating developing sleeve causes toner particles to adhere onto the surface of the photoconductor 2Y, so that a corona product moves from the surface of the photoconductor 2Y to the surfaces of the toner particles. The controller 40 turns on the cleaner 100Y. The first cleaning brush 102Y (depicted in FIG. 3) and the second cleaning brush 112Y (depicted in FIG. 3) scrape the corona product together with the toner particles from the surface of the photoconductor 2Y.

The image forming apparatus 10 executes the corona product removal mode while an image forming operation is not being performed. Thus, operations of the corona product removal mode may not prevent the image forming operation.

The image forming apparatus 10 may execute the corona product removal mode while supplying toner particles from the new toner bottle to the development unit 6Y (i.e., while adjusting the toner density of the toner particles in the development unit 6Y). Namely, the image forming apparatus 10 executes the corona product removal mode after the toner bottle is replaced with a new one. Therefore, the development unit 6Y, the photoconductor 2Y, and the cleaner 100Y need not be operable while the toner bottle is replaced with a new one. Supplying toner particles from the toner bottle to the development unit 6Y and supplying toner particles onto the surface of the photoconductor 2Y in the corona product removal mode cannot be performed simultaneously, and thereby are performed sequentially during the recovery operations in step S52.

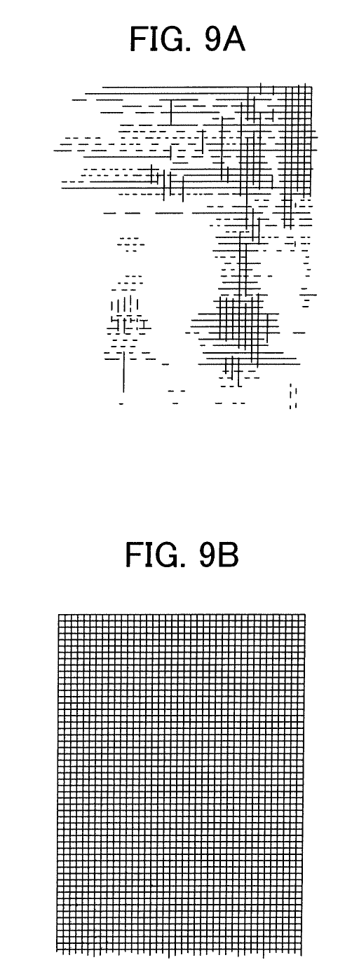

Referring to FIGS. 9A and 9B, the following describes an experiment 1 for removing a corona product from the surface of the photoconductor 2Y (depicted in FIG. 2) by supplying toner particles onto the surface of the photoconductor 2Y. The following describes an overview of procedures of the experiment 1.

In a first step, two photoconductors equivalent to the photoconductor 2Y are prepared. A corona product is adhered to the surface of each of the two photoconductors so that image deletion easily occurs. In a second step, toner particles are uniformly adhered to the surface of one (i.e., a photoconductor X) of the two photoconductors. Toner particles are not adhered to the surface of the other photoconductor (i.e., a photoconductor Y). In a third step, the photoconductors X and Y are left for about an hour. In a fourth step, the toner particles adhered to the surface of the photoconductor X are blown, by air, off the surface of the photoconductor X. The toner particles adhered to the surface of the photoconductor X are not removed by a blade, because the blade may remove the corona product by its mechanical power. In a fifth step, an image is formed on a sheet by using each of the photoconductors X and Y. Whether or not image deletion appears on the formed image is checked to determine whether the corona product is removed or not.

The experiment 1 was performed with a modified printer, Ricoh IPSio color 8200, which formed an image on 1,000 sheets under a temperature of 30 degrees centigrade and a humidity of 90 percent by applying a bias having an alternating current component of Vpp 2.5 kV and f 4 kHz and a direct current component of −700 V to a charging roller equivalent to the charging roller 4Y (depicted in FIG. 2).

When an image was formed on a sheet by using each of the two photoconductors to which a corona product was adhered (i.e., the photoconductors in the condition as described in the first step) according to an original image illustrated in FIG. 9B, image deletion appeared on the formed image as illustrated in FIG. 9A. As illustrated in FIG. 9B, the original image included a grid pattern. When no corona product is adhered to the surface of each of the two photoconductors, the formed image may have the grid pattern as illustrated in FIG. 9B. Namely, the formed image may have vertical and horizontal lines forming the grid pattern. However, when image deletion appeared, the formed image had broken, vertical and horizontal lines as illustrated in FIG. 9A. Thus, the grid pattern was not reproduced.

In the second step, toner particles were uniformly adhered to the surface of the photoconductor X. Specifically, a development unit equivalent to the development unit 6Y (depicted in FIG. 2) developed an electrostatic latent image formed on the surface of the photoconductor X with toner particles to form a toner image. The toner particles forming the toner image were not transferred and remained on the surface of the photoconductor X. Thus, the photoconductor X to which the toner particles were adhered was prepared. For example, the photoconductor X was prepared by removing a transfer unit equivalent to the transfer unit 20 (depicted in FIG. 1).

In the third step, the photoconductor X, to which the toner particles were adhered after the corona product was adhered, and the photoconductor Y, to which toner particles were not adhered, were left for about an hour.

In the fourth step, the toner particles adhered to the photoconductors X and Y were blown off by air.

In the fifth step, an image was formed on A3 size sheets T6200 by using the photoconductors X and Y under the temperature of 30 degrees centigrade and the humidity of 90 percent.

Image deletion did not appear on an image formed by using the photoconductor X, as illustrated in FIG. 9B. However, image deletion appeared on an image formed by using the photoconductor Y, as illustrated in FIG. 9A, even after the photoconductor Y was left for about an hour in the third step. FIGS. 9A and 9B illustrate a part of an image formed in the fifth step.

The experiment 1 shows that image deletion can be prevented or reduced when an image is formed on a sheet by using the photoconductor X. The photoconductor X carried a corona product, which easily causes image deletion, and toner particles, and was left for about an hour. The toner particles carried by the photoconductor X were blown off by air after the photoconductor X was left for about an hour. Namely, mechanical power was not applied to the photoconductor X to remove the toner particles carried by the photoconductor X. Thus, the corona product on the photoconductor X was adhered to the surfaces of the toner particles while the photoconductor X was left for about an hour. The corona product was removed from the surface of the photoconductor X together with the toner particles when the toner particles were blown off by air.

The experiment 1 shows that the corona product can be removed by the toner particles, from the surface of the photoconductor X, instead of by a blade causing friction to remove the corona product.

Referring to FIGS. 9A and 9B, the following describes an experiment 2 for examining effects of the corona product removal mode. The following describes an overview of procedures of the experiment 2.

In a first step, a photoconductor equivalent to the photoconductor 2Y (depicted in FIG. 2) is prepared. A corona product is adhered to the surface of the photoconductor so that image deletion easily occurs. In a second step, a development unit equivalent to the development unit 6Y (depicted in FIG. 2) supplies toner particles onto the surface of the rotating photoconductor while a charging bias is turned off. In a third step, a cleaner equivalent to the cleaner 100Y (depicted in FIG. 3) is turned on. In a fourth step, an image is formed on a sheet by using the photoconductor. Whether or not image deletion appears on the formed image is checked to determine whether the corona product is removed or not.

The first step of the experiment 2 was performed with a test printer equivalent to the image forming apparatus 10 (depicted in FIG. 1), which formed an image on 1,000 sheets under a temperature of 30 degrees centigrade and a humidity of 90 percent by applying a bias having an alternating current component of Vpp 2.5 kV and f 4 kHz and a direct current component of −700 V to a charging roller equivalent to the charging roller 4Y (depicted in FIG. 2).

When an image was formed on a sheet by using the photoconductor to which a corona product was adhered (i.e., the photoconductor in the condition as described in the first step) according to an original image illustrated in FIG. 9B, image deletion appeared on the formed image as illustrated in FIG. 9A like in the experiment 1.

The corona product removal mode was executed in the second and third steps. A developing sleeve of the development unit rotated and a direct current voltage of −50 V was applied. A transfer unit equivalent to the transfer unit 20 (depicted in FIG. 1) was not turned on. Thus, the rotating photoconductor conveyed toner particles supplied from the development unit and adhered to the surface of the photoconductor to the cleaner. A voltage was applied to cleaning brushes equivalent to the first cleaning brush 102Y and the second cleaning brush 112Y (depicted in FIG. 3) included in the cleaner, so that the cleaning brushes collected the toner particles from the surface of the photoconductor. In the fourth step, an image was formed on a sheet. However, image deletion did not appear on the formed image.

When an image was formed on a sheet without performing the procedures in the second and third steps, image deletion appeared on the formed image. Namely, the corona product adhered to the surface of the photoconductor was not removed.

The experiment 2 shows that image deletion can be prevented or reduced by executing the corona product removal mode even in a printer using an electrostatic cleaning method. The cleaner can remove the corona product in the mechanism described for the experiment 1.

The experiments 1 and 2 show that the printers having a structure common to the image forming apparatus 10 (depicted in FIG. 1) can remove the corona product. Specifically, when toner particles are supplied onto the surface of the rotating photoconductor while a charging bias is turned off, the corona product is removed from the surface of the photoconductor and thereby image deletion does not occur.

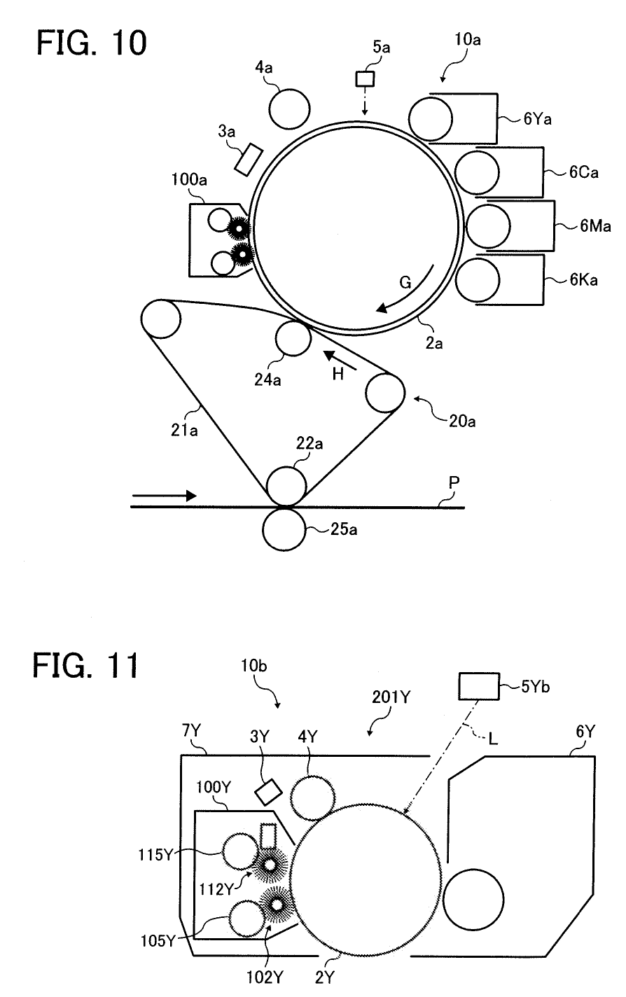

Referring to FIG. 10, the following describes an image forming apparatus 10a including a single photoconductor. As illustrated in FIG. 10, the image forming apparatus 10a includes a photoconductor 2a, a charging roller 4a, an optical writer 5a, four development units 6Ya, 6Ca, 6Ma, and 6Ka, a cleaner 100a, a discharger 3a, and a transfer unit 20a. The transfer unit 20a includes an intermediate transfer belt 21a, a driving roller 22a, a first transfer roller 24a, and a second transfer roller 25a. The development units 6Ya, 6Ca, 6Ma, and 6Ka and the cleaner 100a form a cleaning device for cleaning the surface of the photoconductor 2a. The other elements of the image forming apparatus 10a are common to the image forming apparatus 10 (depicted in FIG. 1).

The image forming apparatus 10a can be a copying machine, a facsimile machine, a printer, a multifunction printer having copying, printing, scanning, and facsimile functions, or the like. According to this non-limiting exemplary embodiment of the present invention, the image forming apparatus 10a functions as a color printer for printing a color image on a recording medium by an electrophotographic method.

The photoconductor 2a, serving as an image carrier, rotates in a rotating direction G. The charging roller 4a, the optical writer 5a, the four development units 6Ya, 6Ca, 6Ma, and 6Ka, the cleaner 100a, and the discharger 3a are disposed around the photoconductor 2a.

The charging roller 4a serving as a charger, the optical writer 5a serving as an electrostatic latent image forming member, and the discharger 3a have structures common to the charging roller 4Y, the optical writer 5Y, and the discharger 3Y (depicted in FIG. 2), respectively.

A moving mechanism (not shown) moves each of the four development units 6Ya, 6Ca, 6Ma, and 6Ka, serving as fine particle suppliers and developing members, back and forth, for example, between a developing position and a standby position. Specifically, each of the development units 6Ya, 6Ca, 6Ma, and 6Ka includes a developing sleeve (not shown). The developing sleeve moves between the developing position and the standby position. At the developing position, the developing sleeve contacts or is positioned close to the photoconductor 2a. At the standby position, the developing sleeve is positioned away from the photoconductor 2a. When the developing sleeve is positioned at the developing position, the developing sleeve develops an electrostatic latent image formed on a surface of the photoconductor 2a.

The optical writer 5a emits light on the surface of the photoconductor 2a to form an electrostatic latent image corresponding to yellow image data. The development unit 6Ya develops the electrostatic latent image with yellow toner to form a yellow toner image on the surface of the photoconductor 2a. The transfer unit 20a serves as a transferor. The intermediate transfer belt 21a, serving as an image carrier and a transfer member, is looped over the driving roller 22a and the first transfer roller 24a. The driving roller 22a rotates the intermediate transfer belt 21a in a rotating direction H. The first transfer roller 24a transfers the yellow toner image formed on the surface of the photoconductor 2a onto an outer circumferential surface of the intermediate transfer belt 21a. While the intermediate transfer belt 21a rotates for three cycles, electrostatic latent images corresponding to cyan, magenta, and black image data are formed on the surface of the photoconductor 2a in this order and the development units 6Ca, 6Ma, and 6Ka develop the electrostatic latent images with cyan, magenta, and black toners to form cyan, magenta, and black toner images, respectively. The cyan, magenta, and black toner images formed on the surface of the photoconductor 2a are transferred onto the outer circumferential surface of the intermediate transfer belt 21a in a manner that the cyan, magenta, and black toner images are superimposed on the yellow toner image transferred on the outer circumferential surface of the intermediate transfer belt 21a. Thus, the yellow, cyan, magenta, and black toner images are transferred on the outer circumferential surface of the intermediate transfer belt 21a.

The second transfer roller 25a is disposed under the intermediate transfer belt 21a. A contact-separate mechanism (not shown) causes the second transfer roller 25a to contact to and separate from the intermediate transfer belt 21a. While the intermediate transfer belt 21a rotates for a plurality of cycles so that the yellow, cyan, magenta, and black toner images formed on the surface of the photoconductor 2a are transferred and superimposed onto the outer circumferential surface of the intermediate transfer belt 21a, the second transfer roller 25a separates from the intermediate transfer belt 21a. After the yellow, cyan, magenta, and black toner images are transferred onto the outer circumferential surface of the intermediate transfer belt 21a, the second transfer roller 25a contacts the outer circumferential surface of the intermediate transfer belt 21a to form a second transfer nip between the second transfer roller 25a and the intermediate transfer belt 21a. At the second transfer nip, the yellow, cyan, magenta, and black toner images superimposed on the outer circumferential surface of the intermediate transfer belt 21a are transferred onto a sheet P.

The cleaner 100a has a structure common to the cleaner 100Y (depicted in FIG. 3). In a corona product removal mode of the image forming apparatus 10a, one of the four development units 6Ya, 6Ca, 6Ma, and 6Ka supplies fine particles (e.g., toner particles) onto the surface of the photoconductor 2a while the image forming apparatus 10a is not performing an image forming operation. The cleaner 100a electrostatically removes the toner particles. Thus, a corona product adhered to the toner particles can be removed from the surface of the photoconductor 2a.

Referring to FIG. 11, the following describes an image forming apparatus 10b including a process unit 201Y for forming a yellow toner image. In the process unit 201Y, a support supports the elements of the process unit 201Y. The process unit 201Y is attachable to and detachable from the image forming apparatus 10b. The image forming apparatus lob may include process units (not shown) for forming cyan, magenta, and black toner images, respectively, which have the structure common to the process unit 201Y.

As illustrated in FIG. 11, the image forming apparatus 10b includes an optical writing unit 5Yb, serving as an electrostatic latent image forming member, and the process unit 201Y. The process unit 201Y includes the photoconductor 2Y, the charging roller 4Y, the development unit 6Y, the cleaner 100Y, and the discharger 3Y, which are common to the image forming apparatus 10 (depicted in FIG. 1), but further includes a casing 7Y. The cleaner 100Y includes the first cleaning brush 102Y, the second cleaning brush 112Y, the first collecting roller 105Y, and the second collecting roller 115Y, which are common to the image forming apparatus 10. The other elements of the image forming apparatus 10b are common to the image forming apparatus 10.

In the process unit 201Y, the casing 7Y, serving as a support, supports the photoconductor 2Y, the charging roller 4Y, the development unit 6Y, the cleaner 100Y, and the discharger 3Y. The optical writer 5Y (depicted in FIG. 2) is not provided in the process unit 201Y. Instead of the optical writer 5Y, the optical writing unit 5Yb for optically scanning the surface of the photoconductor 2Y according to yellow image data is disposed above the process unit 201Y. Optical writing units (not shown) for optically scanning the surfaces of the photoconductors 2C, 2M, and 2K according to cyan, magenta, and black image data are disposed above the process units for forming cyan, magenta, and black images, respectively. The optical writing unit 5Yb includes a known optical system including a laser diode, a polygon mirror, and various mirrors. The optical writing unit 5Yb emits a laser beam L corresponding to yellow image data. The laser beam L reaches the surface of the photoconductor 2Y via an opening (not shown) provided in the casing 7Y.

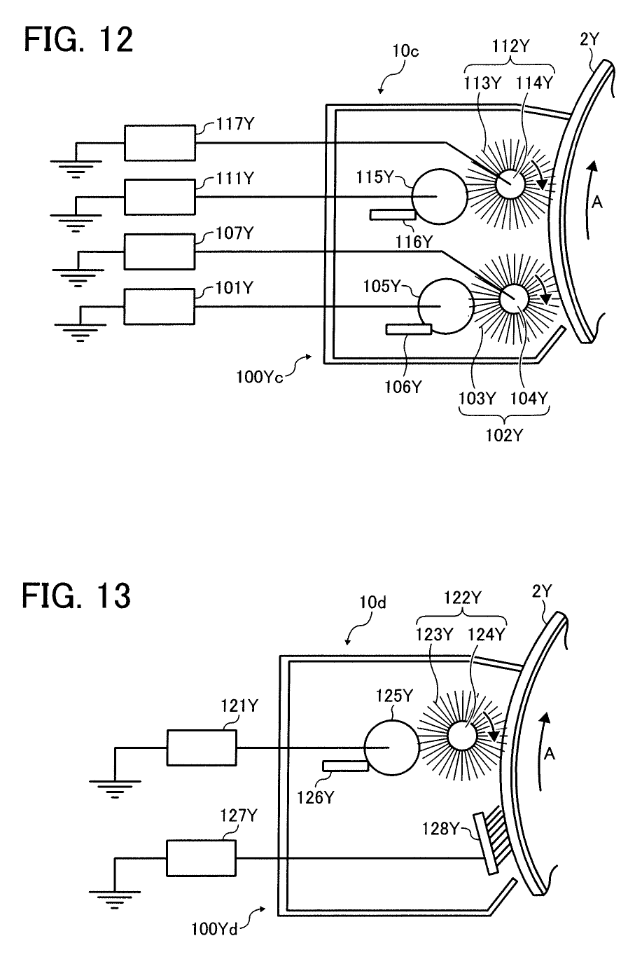

Referring to FIG. 12, the following describes an image forming apparatus 10c including a cleaner 100Yc for cleaning the surface of the photoconductor 2Y. As illustrated in FIG. 12, the cleaner 100Yc includes a first brush power source 107Y and a second brush power source 117Y. The other elements of the image forming apparatus 10c are common to the image forming apparatus 10 (depicted in FIG. 1). In the cleaner 100Yc, the first brush power source 107Y directly applies a voltage to the first cleaning brush 102Y serving as a first cleaning member. The second brush power source 117Y directly applies a voltage to the second cleaning brush 112Y serving as a second cleaning member.

The cleaner 100Yc includes the first cleaning brush 102Y, the second cleaning brush 112Y, the first collecting roller 105Y, the second collecting roller 115Y, the first scraper 106Y, the second scraper 116Y, the first roller power source 101Y, the second roller power source 111Y, and a conveying coil (not shown), which are common to the cleaner 100Y (depicted in FIG. 3). The first cleaning brush 102Y includes the first nap 103Y and the first shaft 104Y, which are common to the cleaner 100Y. The second cleaning brush 112Y includes the second nap 113Y and the second shaft 114Y, which are common to the cleaner 100Y. The first cleaning brush 102Y and the second cleaning brush 112Y contact or are positioned close to the surface of the photoconductor 2Y.

In the image forming apparatus 10c, the cleaner 100Yc and the development unit 6Y (depicted in FIG. 2) form a cleaning device for cleaning the surface of the photoconductor 2Y.

In the cleaner 100Yc, the first cleaning brush 102Y, the second cleaning brush 112Y, the first collecting roller 105Y, the second collecting roller 115Y, the first roller power source 110Y, the second roller power source 111Y, the first brush power source 107Y, and the second brush power source 117Y form an electrostatic cleaning mechanism for electrostatically removing residual toner particles from the surface of the photoconductor 2Y. For example, the first roller power source 101Y applies a voltage to the first collecting roller 105Y. The second roller power source 111Y applies a voltage to the second collecting roller 115Y. The first brush power source 107Y directly applies a voltage to the first cleaning brush 102Y. The second brush power source 117Y directly applies a voltage to the second cleaning brush 112Y.

The first brush power source 107Y applies a bias voltage having a positive polarity to the first shaft 104Y serving as a core of the first cleaning brush 102Y. The second brush power source 117Y applies a bias voltage having a negative polarity to the second shaft 114Y serving as a core of the second cleaning brush 112Y.

In the cleaner 100Yc, the first roller power source 101Y and the first brush power source 107Y apply bias voltages to the first collecting roller 105Y and the first cleaning brush 102Y, respectively. The second roller power source 111Y and the second brush power source 117Y apply bias voltages to the second collecting roller 115Y and the second cleaning brush 112Y, respectively. Thus, toner particles can properly move from the surface of the photoconductor 2Y to the first cleaning brush 102Y and the second cleaning brush 112Y. Further, the toner particles can properly move from the first cleaning brush 102Y and the second cleaning brush 112Y to the first collecting roller 105Y and the second collecting roller 115Y, respectively. As a result, the cleaner 100Yc can provide an increased cleaning property. Namely, even in the corona product removal mode in which an increased amount of toner particles need to be removed, the cleaner 100Yc can properly remove toner particles.

In the cleaner 100Yc, the first roller power source 101Y applies a voltage of about +450 V to the first collecting roller 105Y. The first brush power source 107Y applies a voltage of about +200 V to the first cleaning brush 102Y. The second roller power source 111Y applies a voltage of about −500 V to the second collecting roller 115Y. The second brush power source 117Y applies a voltage of about −250 V to the second cleaning brush 112Y. When the surfaces of the first collecting roller 105Y and the second collecting roller 115Y include an insulating material, the cleaner 100Yc can provide an increased cleaning property.

In the corona product removal mode in which the cleaner 100Yc removes more toner particles than in an image forming mode when an image forming apparatus 10c performs an image forming operation, the first roller power source 101Y, the first brush power source 107Y, the second roller power source 111Y, and the second brush power source 117Y may apply increased voltages to the first collecting roller 105Y, the first cleaning brush 102Y, the second collecting roller 115Y, and the second cleaning brush 112Y, respectively. In the corona product removal mode, almost all toner particles reaching the first and second cleaning positions where the first cleaning brush 102Y and the second cleaning brush 112Y clean the surface of the photoconductor 2Y, respectively, are negatively charged. Therefore, to remove the negatively charged toner particles as much as possible, the first roller power source 101Y and the first brush power source 107Y may apply increased voltages to the first collecting roller 105Y and the first cleaning brush 102Y, respectively. The second roller power source 111Y and the second brush power source 117Y may apply voltages having the positive polarity to the second collecting roller 115Y and the second cleaning brush 112Y, respectively. Thus, the first cleaning brush 102Y and the second cleaning brush 112Y may remove the negatively charged toner particles.

Referring to FIG. 13, the following describes an image forming apparatus led including a cleaner 100Yd for cleaning the surface of the photoconductor 2Y. Each of the cleaner 100Y (depicted in FIGS. 3 and 11), the cleaner 100a (depicted in FIG. 10), and the cleaner 100Yc (depicted in FIG. 12) includes two cleaning brushes (i.e., the first cleaning brush 102Y and the second cleaning brush 112Y). In an image forming mode when the image forming apparatus 10, 10a, 10b, or 10c performs an image forming operation, the two cleaning brushes remove residual toner particles having a positive polarity and residual toner particles having a negative polarity from the surface of the photoconductor 2Y, respectively. The cleaner 100Yd controls toner particles to have one of the positive and negative polarities, and electrostatically removes the controlled toner particles.

As illustrated in FIG. 13, the cleaner 100Yd includes a cleaning brush 122Y, a collecting roller 125Y, a roller power source 121Y, a scraper 126Y, a polarity control brush 128Y, and a polarity control brush power source 127Y. The cleaning brush 122Y includes a shaft 124Y and a nap 123Y. The cleaner 100Yd further includes a conveying coil (not shown). The cleaning brush 122Y, the collecting roller 125Y, and the roller power source 121Y form an electrostatic cleaning mechanism for electrostatically removing residual toner particles from the surface of the photoconductor 2Y. In the image forming apparatus 10d, the cleaner 100Yd and the development unit 6Y (depicted in FIG. 2) form a cleaning device for cleaning the surface of the photoconductor 2Y. The other elements of the image forming apparatus 10d are common to the image forming apparatus 10 (depicted in FIG. 1).

The cleaning brush 122Y, the collecting roller 125Y, the roller power source 121Y, the scraper 126Y, the shaft 124Y, and the nap 123Y have structures common to the first cleaning brush 102Y or the second cleaning brush 112Y, the first collecting roller 105Y or the second collecting roller 115Y, the first roller power source 101Y or the second roller power source 111Y, the first scraper 106Y or the second scraper 116Y, the first shaft 104Y or the second shaft 114Y, and the first nap 103Y or the second nap 113Y (depicted in FIG. 3), respectively. For example, the collecting roller 125Y contacts the cleaning brush 122Y. The roller power source 121Y applies a voltage to the collecting roller 125Y. The scraper 126Y contacts the collecting roller 125Y.

The polarity control brush 128Y serves as a polarity controller for controlling the polarity of toner particles. The cleaning brush 122Y, serving as a cleaning member, contacts or is positioned close to the surface of the photoconductor 2Y. The polarity control brush 128Y is disposed upstream from a cleaning position formed between the photoconductor 2Y and the cleaning brush 122Y opposing each other in the rotating direction A of the photoconductor 2Y. The polarity control brush power source 127Y applies a voltage to the polarity control brush 128Y.

The following describes the polarity controller. Residual toner particles remaining on the surface of the photoconductor 2Y contain toner particles having a normal polarity (i.e., a negative polarity) and toner particles having an opposite polarity (i.e., a positive polarity). The polarity controller causes the residual toner particles to have one of the negative and positive polarities by a friction charge generated when the polarity controller contacts toner particles, charge injection, or weak electric discharge. The residual toner particles may be controlled to have either the negative polarity or the positive polarity.

When the residual toner particles are charged by friction, the polarity of the toner particles changes after the toner particles are charged by friction according to a friction charging property of a material contacting the toner particles. When the residual toner particles are charged by charge injection, the toner particles are positively charged when a voltage having a positive polarity is applied to the polarity controller. The toner particles are negatively charged when a voltage having a negative polarity is applied to the polarity controller. A voltage applied to the polarity controller may be either a direct current voltage or a voltage in which an alternating current is superimposed on a direct current. However, when an alternating current is superimposed on a direct current, the toner particles can be uniformly charged.

As illustrated in FIG. 13, when the polarity control brush power source 127Y applies a voltage having a negative polarity to the polarity control brush 128Y, the roller power source 121Y applies a voltage having a positive polarity to the collecting roller 125Y. The collecting roller 125Y contacts the cleaning brush 122Y to cause the cleaning brush 122Y, serving as a cleaning member, to carry an electric charge. The polarity control brush power source 127Y may apply a voltage having a positive polarity to the polarity control brush 128Y. In this case, the roller power source 121Y applies a voltage having a negative polarity to the collecting roller 125Y.

The polarity controller includes a blade, a brush (e.g., a magnetic brush), a roller, and a belt, which includes a conductive material. The polarity control brush 128Y includes a conductive material. When the polarity controller has a brush shape, a conductive resin is dispersed in a fiber forming the brush. The conductive resin may be dispersed throughout the fiber, in an outer circumferential portion of the fiber, or in an inner portion of the fiber.

The following describes the cleaning member (i.e., the cleaning brush 122Y). The cleaning brush 122Y, the collecting roller 125Y, and the roller power source 121Y electrostatically remove residual toner particles of which polarity is controlled by the polarity controller (i.e., the polarity control brush 128Y) from the surface of the photoconductor 2Y. In the cleaner 100Yd, the cleaning brush 122Y sliding on the surface of the photoconductor 2Y and carrying an electric charge having a positive polarity removes residual toner particles controlled by the polarity control brush 128Y to have a negative polarity from the surface of the photoconductor 2Y.

The roller power source 121Y applies a voltage to the collecting roller 125Y so that the collecting roller 125Y applies an electric charge to the cleaning brush 122Y. Therefore, the cleaning brush 122Y includes a conductive material.

As described above, the polarity control brush 128Y causes toner particles on the surface of the photoconductor 2Y to have one of the negative and positive polarities. The roller power source 121Y applies a voltage having a polarity opposite to the polarity of the toner particles to the cleaning brush 122Y. Thus, the cleaning brush 122Y can remove the toner particles from the surface of the photoconductor 2Y.

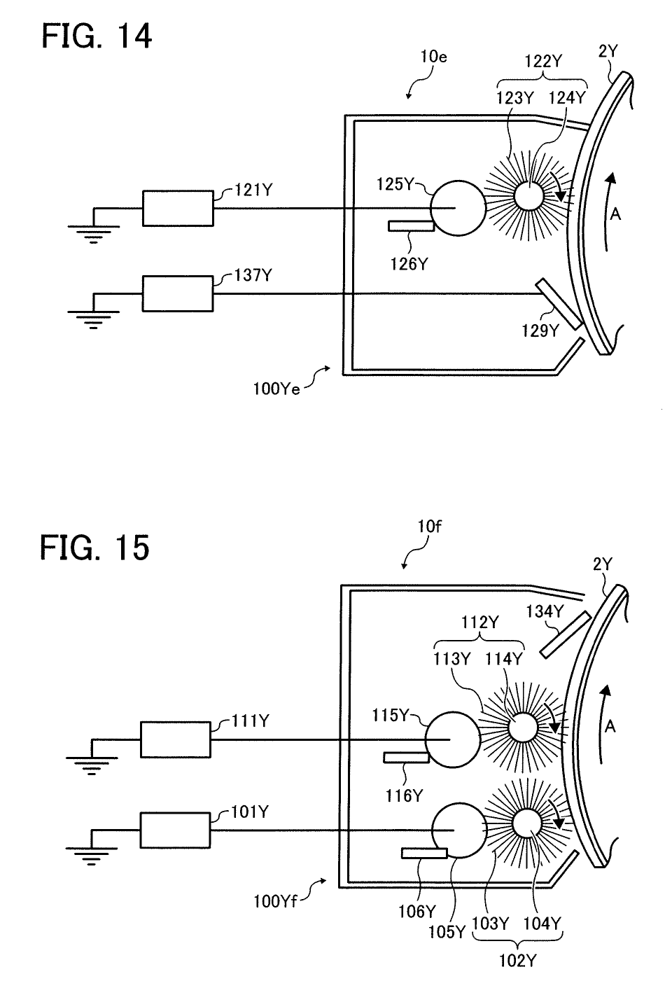

Referring to FIG. 14, the following describes an image forming apparatus 10e including a cleaner 100Ye for cleaning the surface of the photoconductor 2Y. The cleaner 100Ye includes a polarity controller having a blade shape. As illustrated in FIG. 14, the cleaner 100Ye includes the cleaning brush 122Y, the collecting roller 125Y, the roller power source 121Y, the scraper 126Y, a polarity control blade 129Y, and a polarity control blade power source 137Y. The cleaning brush 122Y includes the shaft 124Y and the nap 123Y. The cleaning brush 122Y, the collecting roller 125Y, and the roller power source 121Y form an electrostatic cleaning mechanism for electrostatically removing residual toner particles from the surface of the photoconductor 2Y. In the image forming apparatus 10e, the cleaner 100Ye and the development unit 6Y (depicted in FIG. 2) form a cleaning device for cleaning the surface of the photoconductor 2Y. The other elements of the image forming apparatus 10e are common to the image forming apparatus 10 (depicted in FIG. 1).

The cleaning brush 122Y, serving as a cleaning member, contacts or is positioned close to the surface of the photoconductor 2Y. The polarity control blade 129Y serves as a polarity controller for controlling the polarity of toner particles. The polarity control blade 129Y is disposed upstream from a cleaning position formed between the photoconductor 2Y and the cleaning brush 122Y opposing each other in the rotating direction A of the photoconductor 2Y. The polarity control blade power source 137Y applies a voltage to the polarity control blade 129Y.

When a conductive blade is used as the polarity control blade 129Y, the conductive blade contacts the surface of the photoconductor 2Y in a direction counter to the rotating direction A of the photoconductor 2Y or in a direction trailing to the rotating direction A of the photoconductor 2Y. The conductive blade has an elastic modulus of from about 20 percent to about 80 percent and a thickness of from about 1 mm to about 6 mm. The conductive blade may preferably contact the surface of the photoconductor 2Y at an angle of from about 15 degrees to about 45 degrees, when the conductive blade contacts the surface of the photoconductors 2Y in the direction counter to the rotating direction A of the photoconductor 2Y. The conductive blade may preferably contact the surface of the photoconductor 2Y at an angle of from about 90 degrees to about 175 degrees, when the conductive blade contacts the surface of the photoconductor 2Y in the direction trailing the rotating direction A of the photoconductor 2Y.

The polarity controller may have a roller or a belt shape. When the polarity controller has a roller shape, the polarity controller may be a conductive, elastic roller or a conductive, hard roller, which includes a plurality of layers in a radial direction of the roller. The plurality of layers have different resistivities from each other.

When the polarity controller has a belt shape, the polarity controller may be a conductive, elastic belt including a plurality of layers in a thickness direction of the belt. The plurality of layers have different resistivities from each other.

Referring to FIG. 15, the following describes an image forming apparatus 10f including a cleaner 100Yf for cleaning the surface of the photoconductor 2Y. The cleaner 100Yf includes the elements common to the cleaner 100Y (depicted in FIG. 3), but further includes a cleaning blade 134Y. The other elements of the image forming apparatus 10f are common to the image forming apparatus 10 (depicted in FIG. 1).

The cleaner 100Yf includes the first cleaning brush 102Y, the second cleaning brush 112Y, the first collecting roller 105Y, the second collecting roller 115Y, the first scraper 106Y, the second scraper 116Y, the first roller power source 110Y, and the second roller power source 111Y, which are common to the cleaner 100Y (depicted in FIG. 3). The first cleaning brush 102Y includes the first nap 103Y and the first shaft 104Y, which are common to the cleaner 100Y. The second cleaning brush 112Y includes the second nap 113Y and the second shaft 114Y, which are common to the cleaner 100Y. The first cleaning brush 102Y, serving as a first cleaning member, and the second cleaning brush 112Y, serving as a second cleaning member, contact or are positioned close to the surface of the photoconductor 2Y.

In the image forming apparatus 10f, the cleaner 100Yf and the development unit 6Y (depicted in FIG. 2) form a cleaning device for cleaning the surface of the photoconductor 2Y.

In the cleaner 100Yf, the first cleaning brush 102Y, the second cleaning brush 112Y, the first collecting roller 105Y, the second collecting roller 115Y, the first roller power source 101Y, and the second roller power source 111Y form an electrostatic cleaning mechanism for electrostatically removing residual toner particles from the surface of the photoconductor 2Y.

In the cleaner 100Yf, a bracket (not shown) supports one end of the cleaning blade 134Y. The other end (i.e., a free end) of the cleaning blade 134Y contacts the surface of the photoconductor 2Y. Toner particles on the surface of the photoconductor 2Y pass the first cleaning position where the first cleaning brush 102Y contacts the photoconductor 2Y, the second cleaning position where the second cleaning brush 112Y contacts the photoconductor 2Y, and a third cleaning position where the cleaning blade 134Y contacts the photoconductor 2Y. The cleaning blade 134Y scrapes toner particles not removed by the first cleaning brush 102Y and the second cleaning brush 112Y from the surface of the photoconductor 2Y.

The cleaning blade 134Y includes an abrasive blade covered by an abrasive layer including an elastic material containing abrasive particles. A foreign substance in addition to residual toner particles is adhered to the surface of the photoconductor 2Y. Examples of the foreign substance include inorganic fine particles separated from toner particles, an additive (e.g., wax) seeped from toner particles, and calcium carbonate contained in iron powder included in a sheet P. When the foreign substance is not removed and remains on the surface of the photoconductor 2Y, the foreign substance may film the surface of the photoconductor 2Y or may form a core or a mass. The first cleaning brush 102Y and the second cleaning brush 112Y may not easily remove the foreign substance. However, the cleaning blade 134Y can remove the foreign substance by utilizing a scraping property provided by the abrasive layer.

The abrasive layer includes a contact surface for contacting the surface of the photoconductor 2Y. The contact surface is filled with abrasive particles. The abrasive particles are added and dispersed so that the abrasive particles contained in the contact surface have a volume occupancy not smaller than about 40 percent and not greater than about 90 percent. When the volume occupancy is smaller than about 40 percent, a proper amount of abrasive particles do not contact the surface of the photoconductor 2Y. As a result, the abrasive particles may not prevent a foreign substance from filming the surface of the photoconductor 2Y. When the volume occupancy is greater than about 90 percent, abrasive particles protruding from the surface of the abrasive layer may easily fall off the abrasive layer.

In addition to the abrasive layer, a blade base layer may be provided on the surface of the cleaning blade 134Y. To form the abrasive layer only, abrasive particles are mixed with an elastic material, and molded into a sheet by centrifugal molding. The sheet is cut into the abrasive layer. To form the blade base layer in addition to the abrasive layer, abrasive particles and an elastic material, in amounts smaller than the amounts used for forming the abrasive layer only, respectively, are mixed, and molded into a thin sheet. The sheet is cut into a thin film including the abrasive layer. The thin film is adhered to the blade base layer including a rubber, a resin, and/or a metal. Alternatively, a material (e.g., a resin, a metal, and/or the like) forming the blade base layer is flown onto a thin sheet molded by adding abrasive particles, and is molded into an integrated sheet by centrifugal molding. The integrated sheet is cut into the abrasive layer and the blade base layer.

The cleaning blade 134Y includes elastic materials (e.g., a fluorocarbon rubber, a silicon rubber, a butyl rubber, a butadiene rubber, an isoprene rubber, an urethane rubber, and/or the like). Among the above, the urethane rubber is preferable to improve wear resistance. The above-described rubbers preferably have a hardness not smaller than about 65 degrees and not greater than about 95 degrees. When the hardness is smaller than about 65 degrees, the cleaning blade 134Y may wear fast. When the hardness is greater than about 95 degrees, the edge of the cleaning blade 134Y may easily chip. The rubbers more preferably have a hardness not smaller than about 85 degrees and not greater than about 95 degrees. When the hardness is not smaller than about 85 degrees, the cleaning blade 134Y contacts the surface of the photoconductor 2Y at a decreased area with an increased pressure, resulting in an improved abrasive force. The abrasive particles may not dig the cleaning blade 134Y, maintaining an improved abrasive force. The elastic materials preferably have a decreased dynamic friction coefficient. Examples of the elastic materials include an urethane rubber having a fluoridized surface and an urethane rubber containing a fluoro element.

The cleaning blade 134Y includes a head portion for contacting the surface of the photoconductor 2Y. The head portion may include a rubber having an increased hardness. When the head portion does not include a material having an increased hardness, a reinforcing member (e.g., a mylar) may be adhered to the back of the cleaning blade 134Y to increase the hardness of the cleaning blade 134Y and thereby to improve the abrasive force. The abrasive layer can be properly positioned to contact the surface of the photoconductor 2Y.

Examples of the abrasive particles include nitrides (e.g., silicon nitride and/or the like), silicates (e.g., aluminum silicate, magnesium silicate, mica, calcium silicate, and/or the like), calcaleous substances (e.g., calcium carbonate, gypsum, and/or the like), carbides (e.g., silicon carbide, boron carbide, tantalum carbide, titanium carbide, aluminum carbide, zirconium carbide, and/or the like), and/or oxides (e.g., cerium oxide, chromium oxide, titanium oxide, aluminum oxide, and/or the like). Among the above, cerium oxide, which provides an improved abrasive force, is preferable.

The abrasive particles preferably include a plurality of particles having average particle sizes and types different from each other. When the abrasive particles having average particle sizes and types different from each other are mixed, the abrasive particles provide different abrasive forces. By utilizing the different abrasive forces, the cleaning blade 134Y can effectively remove foreign substances of various types (e.g., a thin film and a mass formed when fine particles become a core and grow) from the surface of the photoconductor 2Y.

The abrasive layer preferably includes cerium oxide having a purity not smaller than about 80 percent. Cerium oxide provides an improved abrasive force, but has a decreased purity of about 50 percent because cerium oxide is generally manufactured by pulverizing a natural ore. Other rare earthes are processed into a salt and mixed so as to provide an improved abrasive force. However, cerium oxide and other rare earthes may not provide a constant property. Thus, the cleaning blade 134Y may not provide a constant abrasive performance. To address this problem, the abrasive layer includes cerium oxide having a purity not smaller than about 80 percent obtained by extracting cerium oxide providing an improved abrasive force as an abrasive providing a constant property. As a result, the cleaning blade 134Y can stably provide an improved abrasive force.

The abrasive particles preferably have an average particle size not smaller than about 0.05 μm and not greater than about 100 μm. When the abrasive particles have an average particle size smaller than about 0.05 μm, the abrasive particles are too small to be uniformly dispersed in an elastic material. As a result, the cleaning blade 134Y may not provide a proper abrasive force. When the abrasive particles have an average particle size greater than about 100 μm, the cleaning blade 134Y provides a great abrasive force, damaging the surface of the photoconductor 2Y.

The edge of the abrasive layer is preferably cut to properly contact the surface of the photoconductor 2Y. Microscopically, the abrasive particles of the abrasive layer are not exposed, and the surface of the abrasive layer is covered with a skin layer including an elastic material (e.g., a thin rubber and/or the like). Thus, when the cleaning blade 134Y is new and not used, the cleaning blade 134Y may not provide a proper abrasive property. When the cleaning blade 134Y is used and the abrasive particles are exposed from the cut edge of the surface of the abrasive layer, the cleaning blade 134Y can provide a proper abrasive property. Therefore, the edge of the abrasive layer (i.e., the contact surface for contacting the surface of the photoconductor 2Y) is cut, so that the abrasive particles are exposed from the abrasive layer. Thus, the cleaning blade 134Y can provide a proper abrasive property even when the cleaning blade 134Y is new and not used.

When the edge of the abrasive layer is not cut, the photoconductor 2Y is rotated for a predetermined time period without forming an image until the edge of the abrasive layer is cut. Thus, the cleaning blade 134Y can provide a proper abrasive property even when an image forming operation is performed with the cleaning blade 134Y which is new and not used.

As illustrated in FIG. 15, the free end of the cleaning blade 134Y is disposed downstream from the other end (i.e., a fixed end supported by the bracket) in the rotating direction A of the photoconductor 2Y. Namely, the cleaning blade 134Y is disposed at a trailing position. However, the cleaning blade 134Y may be disposed at a counter position in which the free end of the cleaning blade 134Y is disposed upstream from the fixed end in the rotating direction A of the photoconductor 2Y. At the trailing position, the cleaning blade 134Y provides a foreign substance removing property lower than the property provided when the cleaning blade 134Y is disposed at the counter position. However, the cleaning blade 134Y may not curl up at the trailing position as easily as at the counter position. At the trailing position, the cleaning blade 134Y preferably contacts the surface of the photoconductor 2Y at an angle of from about 5 degrees to about 25 degrees. When the angle is smaller than about 5 degrees, the cleaning blade 134Y creeps on the surface of the photoconductor 2Y. As a result, the cleaning blade 134Y may not stably provide a proper abrasive property for a long time period. When the angle is greater than about 25 degrees, the photoconductor 2Y rotating back when an image forming job is finished may curl up the cleaning blade 134Y.

The cleaning blade 134Y preferably contacts the photoconductor 2Y by applying a pressure of from about 10 gf/cm to about 80 gf/cm. When the pressure is smaller than about 10 gf/cm, the cleaning blade 134Y may not properly contact the photoconductor 2Y, resulting in faulty cleaning. When the pressure is greater than about 80 gf/cm, the cleaning blade 134Y may substantially scrape the surface of the photoconductor 2Y, resulting in a short life of the photoconductor 2Y.

The cleaning blade 134Y preferably bites the photoconductor 2Y for a length of from about 0.2 mm to about 1.5 mm, which is calculated based on the hardness of the cleaning blade 134Y and the pressure applied by the cleaning blade 134Y to the photoconductor 2Y. Thus, the cleaning blade 134Y can properly remove a foreign substance without substantially scraping the surface of the photoconductor 2Y.

When the cleaning blade 134Y continuously contacts the photoconductor 2Y, the cleaning blade 134Y scrapes the surface of the photoconductor 2Y too much, resulting in a short life of the photoconductor 2Y. To address this problem, a contact-separate mechanism (not shown) for causing the cleaning blade 134Y to contact to and separate from the photoconductor 2Y as needed may be provided. The contact-separate mechanism causes the cleaning blade 134Y to contact the photoconductor 2Y when cleaning is needed. Thus, the cleaning blade 134Y may not shorten the life of the photoconductor 2Y. When a printing job starts, cleaning is not needed, and residual toner particles are not adhered to the surface of the photoconductor 2Y. However, the cleaning blade 134Y may contact the photoconductor 2Y for a predetermined time period. Thus, a printing job is performed after a foreign substance is removed from the surface of the photoconductor 2Y, resulting in stable image forming operations.

The cleaner 100Yf may include a rotating member (not shown) instead of the cleaning blade 134Y. For example, an elastic layer including a rubber is formed on a circumferential surface of a shaft including a metal. An abrasive layer including abrasive particles is formed on the elastic layer. Alternatively, a foam layer may be formed on a circumferential surface of a shaft including a metal. An abrasive layer including abrasive particles may be formed on a surface of the foam layer. In this case, the rotating member cannot grind a part on the surface of the photoconductor 2Y, which opposes a hole of the foam layer. Therefore, a swing mechanism (not shown) for swinging the rotating member in an axial direction of the photoconductor 2Y is needed. The swing mechanism causes the abrasive layer to properly contact the surface of the photoconductor 2Y. When the rotating member includes the foam layer, elastic deformation of the foam layer causes the abrasive layer to properly contact the surface of the photoconductor 2Y even when the rotating member applies a relatively weak pressure to the photoconductor 2Y. Namely, the contact-separate mechanism is not needed.

The rotating member may rotate continuously or for a predetermined time period. For example, when the rotating member rotates whenever the surface of the abrasive layer wears, the rotating member can maintain a grinding performance for a long time period.

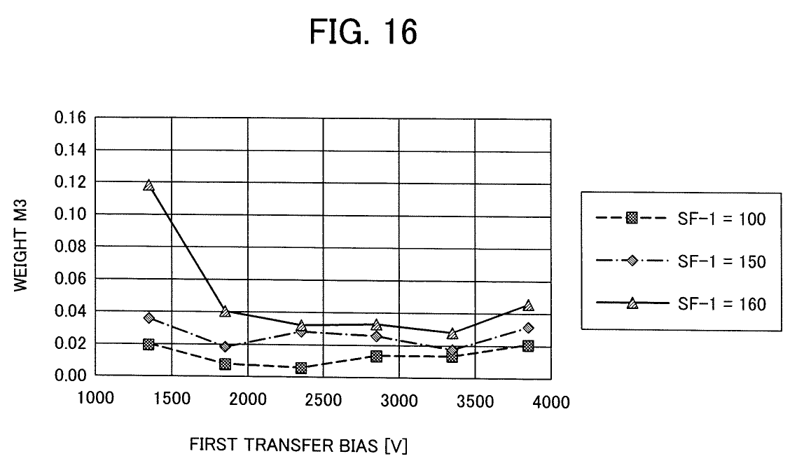

FIG. 16 illustrates a result of an experiment for measuring an amount of residual toner particles remaining on the surface of the photoconductor 2Y. Three types of toner particles were prepared, i.e., toner particles having shape factors SF-1 of 100, 150, and 160. A test image was formed with each of the three types of toner particles, and the amount of residual toner particles remaining on the surface of the photoconductor 2Y was measured. A developing bias was properly adjusted so that a similar amount of toner particles was adhered to the surface of the photoconductor 2Y per unit area. A sucking jig picked up toner particles adhered to a test image on the surface of the photoconductor 2Y immediately after the test image was developed. The weight of the picked-up toner particles was measured as a weight M1. The sucking jig picked up toner particles adhered to the test image transferred on the intermediate transfer belt 21 (depicted in FIG. 1). The weight of the picked-up toner particles was measured as a weight M2. The weight M2 was subtracted from the weight M1 to calculate a weight M3.

As illustrated in FIG. 16, the weight M3 is small when toner particles having the shape factor SF-1 of 100 are used. The greater the shape factor SF-1 is, the greater the weight M3 is. Namely, when the shape factor SF-1 of toner particles is small, a small amount of toner particles can be adhered to the surface of the photoconductor 2Y. Generally, as a smaller amount of toner particles are adhered to the surface of the photoconductor 2Y, the cleaner (i.e., the cleaner 100Y, 100a, 100Yc, 100Yd, 100Ye, or 100Yf) can receive a smaller load, resulting in a long life of the cleaner. Namely, when the cleaner removes toner particles having a small shape factor SF-1, the cleaner can have a long life. Therefore, the image forming apparatus 10 (depicted in FIG. 1) executing the corona product removal mode illustrated in FIG. 5 uses toner particles having the shape factor SF-1 of from about 100 to about 150.

Toner particles used in the experiment were produced by dissolving or dispersing a toner material containing a binder resin including an urea-modified polyester resin and a colorant in an organic solvent to produce a dispersion liquid, forming toner particles in an aqueous medium and causing polyaddition reaction, removing the solvent from the dispersion liquid, and washing and drying the toner particles. Spherical toner particles having a large average roundness may be produced by a polymerization method (e.g., an emulsion polymerization method, a suspension polymerization method, a dispersion polymerization method, and/or the like) as well as by the above-described method. Spherical toner particles having a large average roundness may also be produced by heating toner particles produced by a pulverization method.

The shape factor SF-1 indicates a degree of roundness of a spherical substance (e.g., a toner particle) and is represented by an equation 1 below. The shape factor SF-1 (i.e., I in the equation 1) of the toner particle is calculated by squaring a maximum length MXLNG (i.e., J in the equation 1) of the toner particle projected on a two-dimensional plane and having an ellipse shape, dividing the squared value by an area AREA (i.e., K in the equation 1) of the projected toner particle, and multiplying the divided value by 100×π/4.
I=(J²/K)×(100×π/4) Equation 1

Toner particles in an amount of not fewer than 100 pieces are extracted at random from a toner. An average shape factor SF-1 is calculated based on the shape factors SF-1 of the extracted toner particles and is defined as a shape factor SF-1 of the extracted toner particles.

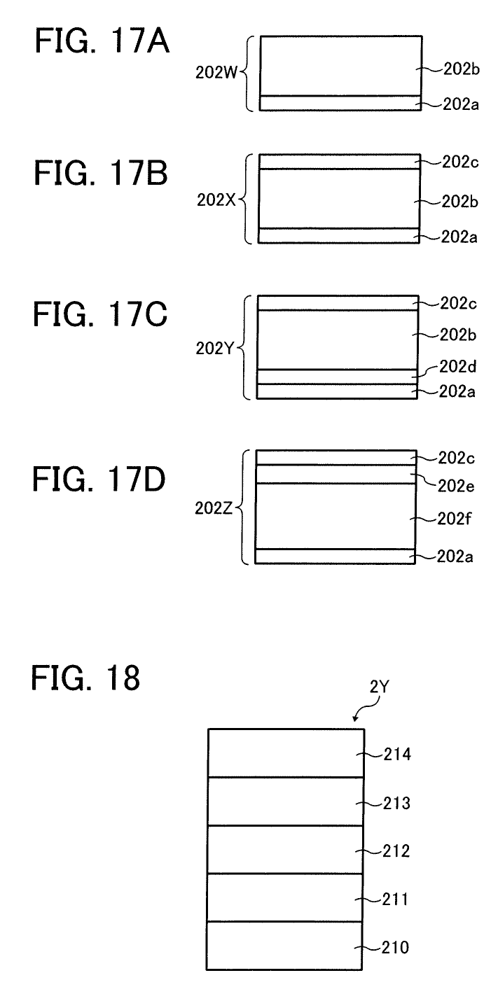

Referring to FIGS. 17A, 17B, 17C, and 17D, the following describes photoconductors 202W, 202X, 202Y, and 202Z including a surface layer containing amorphous silicon. The photoconductors 202W, 202X, 202Y, and 202Z can be installed in the image forming apparatus 10 (depicted in FIG. 1), 10a (depicted in FIG. 10), 10b (depicted in FIG. 11), 10c (depicted in FIG. 12), 10d (depicted in FIG. 13), 10e (depicted in FIG. 14), or 10f (depicted in FIG. 15). The photoconductors 202W, 202X, 202Y, and 202Z can handle a toner in yellow, magenta, cyan, or black color.

As illustrated in FIG. 17A, the photoconductor 202W includes a conductive support 202a and a photoconductive layer 202b. The photoconductive layer 202b is formed on the conductive support 202a. The photoconductive layer 202b includes amorphous silicon and has a photoconductive property.

As illustrated in FIG. 17B, the photoconductor 202X includes the conductive support 202a, the photoconductive layer 202b, and a surface layer 202c. The surface layer 202c is formed on the photoconductive layer 202b and includes amorphous silicon.

As illustrated in FIG. 17C, the photoconductor 202Y includes the conductive support 202a, the photoconductive layer 202b, the surface layer 202c, and a block layer 202d. The block layer 202d is sandwiched between the conductive support 202a and the photoconductive layer 202b, and blocks amorphous silicon charge injection.

As illustrated in FIG. 17D, the photoconductor 202Z includes the conductive support 202a, the surface layer 202c, a charge generating layer 202e, and a charge transport layer 202f. The charge transport layer 202f is formed on the conductive support 202a, and includes amorphous silicon. The charge generating layer 202e is formed on the charge transport layer 202f. The surface layer 202c is formed on the charge generating layer 202e.

As illustrated in FIGS. 17A, 17B, 17C, and 17D, the photoconductors 202W, 202X, 202Y, and 202Z include the photoconductive layer 202b and the surface layer 202c as an outermost layer, respectively. The photoconductive layer 202b and the surface layer 202c include amorphous silicon, providing an improved endurance.

Referring to FIG. 18, the following describes an example of the photoconductor 2Y (depicted in FIG. 2). The photoconductor 2Y includes a conductive support 210, an insulating layer 211, a charge generating layer 212, a charge transport layer 213, and a surface layer 214. The photoconductor 2Y is a negatively charged, organic photoconductor. The conductive support 210 has a drum shape having a diameter of about 30 mm. The insulating layer 211 is formed on the conductive support 210. The charge generating layer 212 and the charge transport layer 213, serving as a photosensitive layer, are formed on the insulating layer 211. The surface layer 214 is formed on the charge transport layer 213 to cover the charge transport layer 213. The surface layer 214 includes a material in which a powdery dispersant is dispersed.

The conductive support 210 includes a conductive material having a volume resistivity of not greater than about 10¹⁰ Ω·cm. For example, the conductive support 210 is manufactured by covering a film or a cylinder including plastic or paper with metals (e.g., aluminum, nickel, chrome, nichrome, copper, gold, silver, platinum, and/or the like) and/or metal oxides (e.g., tin oxide, indium oxide, and/or the like) by evaporating or spattering. Alternatively, the conductive support 210 is manufactured by deforming a plate including aluminum, an aluminum alloy, nickel, and/or stainless steel into a pipe by an extruding or drawing process and performing surface processing (e.g., cutting, superfinishing, grinding, and/or the like) on a surface of the pipe. A known endless nickel belt or a known endless stainless steel belt can be used as the conductive support 210.

The conductive support 210 may include a conductive layer formed by applying a material produced by dispersing a conductive powder in a proper binder resin on a surface of the conductive support 210. Examples of the conductive powder include carbon black, acetylene black, metal powders (e.g., aluminum, nickel, iron, nichrome, copper, zinc, silver, and/or the like), and/or metal oxide powders (e.g., a conductive tin oxide, indium tin oxide, and/or the like). Examples of the binder resin include thermoplastic, thermosetting resins and/or UV (ultraviolet) curable resins (e.g., polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, a polyarylate resin, a phenoxy resin, polycarbonate, a cellulose acetate resin, an ethyl cellulose resin, polyvinyl butyral, polyvinyl formal, polyvinyl toluene, poly-N-vinyl carbazole, an acrylic resin, a silicon resin, an epoxy resin, a melamine resin, an urethane resin, a phenolic resin, an alkyd resin, and/or the like) . The conductive layer is produced by dispersing the above-described conductive powder and the binder resin in a proper solvent (e.g., tetrahydrofuran, dichloromethane, methyl ethyl ketone, toluene, and/or the like) and applying the dispersed solvent to the surface of the conductive support 210.

Alternatively, the conductive layer may be formed by providing a heat-shrinkable tube produced by adding the above-described conductive powder to a material (e.g., polyvinyl chloride, polypropylene, polyester, polystyrene, polyvinylidene chloride, polyethylene, a chlorinated rubber, Teflon®, and/or the like) on a proper cylindrical base.

The photoconductor 2Y includes a plurality of layers (i.e., the charge generating layer 212 and the charge transport layer 213) as the photosensitive layer. However, the photoconductor 2Y may include a single layer as the photosensitive layer.

The charge generating layer 212 includes a charge generating substance as a main ingredient. For example, the charge generating layer 212 may include known charge generating substances (e.g., a monoazo pigment, a disazo pigment, a trisazo pigment, a perylene pigment, a perynon pigment, a quinacridone pigment, a quinine condensed polycyclic compound, a squaric acid dye, a phthalocyanine pigment, a naphthalocyanine pigment, an azlenium salt dye, and/or the like). The charge generating layer 212 may include one of the above-described substances or a mixture of two or more of the above-described substances.

The charge generating layer 212 is produced by dispersing the charge generating substance together with a binder resin as needed in a proper solvent with a ball mill, an attritor, a sand mill, or an ultrasonic mill, applying the dispersed solvent on a surface of the conductive support 210 or the insulating layer 211, and drying the applied solvent.

The charge generating layer 212 may include the above-described charge generating substance dispersed in the binder resin as needed. Examples of the binder resin include polyamide, polyurethane, an epoxy resin, polyketone, polycarbonate, a silicon resin, an acrylic resin, polyvinyl butyral, polyvinyl formal, polyvinyl ketone, polystyrene, polysulfone, poly-N-vinyl carbazole, polyacrylamide, polyvinyl benzale, polyester, a phenoxy resin, a vinyl chloride-vinyl acetate copolymer, polyvinyl acetate, a polyphenylene oxide, polyamide, polyvinyl pyridine, a cellulosic resin, casein, polyvinyl alcohol, and/or polyvinyl pyrrolidone. The amount of the binder resin ranges from about 0 parts by weight to about 500 parts by weight, and preferably ranges from about 10 parts by weight to about 300 parts by weight, with respect to the charge generating substance of about 100 parts by weight. The binder resin may be added before or after the charge generating substance is dispersed.

Examples of the solvent include isopropanol, acetone, methyl ethyl ketone, cyclohexanone, tetrahydrofuran, dioxane, ethyl celsolve, ethyl acetate, methyl acetate, dichloromethane, dichloroethane, monochloro benzene, cyclohexane, toluene, xylene, and/or ligroin. Ketone solvents, ester solvents, and ether solvents are preferable. The solvent may include one of the above-described substances or a mixture of two or more of the above-described substances.

The charge generating layer 212 includes the charge generating substance, the solvent, and the binder resin as main ingredients. However, the charge generating layer 212 may include any additive (e.g., a sensitizer, a dispersant, a surfactant, a silicon oil, and/or the like).

An applying liquid is applied by soaking, spray-coating, bead-coating, nozzle-coating, spinner-coating, and/or ring-coating.

The charge generating layer 212 has a thickness of from about 0.01 μm to about 5 μm and preferably has a thickness of from about 0.1 μm to about 2 μm.

The charge transport layer 213 is produced by dissolving or dispersing a charge transport substance and a binder resin in a proper solvent, applying the dispersed solvent on a surface of the charge generating layer 212, and drying the applied solvent. One or more of a plasticizer, a leveling agent, an antioxidant, and/or the like may be added as needed.

The charge transport substance includes a hole transport substance and an electron transport substance. Examples of the electron transport substance include electron accepting substances (e.g., chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, a benzoquinone derivative, and/or the like).

Examples of the hole transport substance include poly-N-vinyl carbazole and a derivative thereof, poly-γ-carbazole ethyl glutamate and a derivative thereof, a pyrene-formaldehyde condensate and a derivative thereof, polyvinyl pyrene, polyvinyl phenanthrene, polysilane, an oxazole derivative, an oxadiazole derivative, an imidazole derivative, a monoallylamine derivative, a diallylamine derivative, a triallylamine derivative, a stilbene derivative, an α-phenylstilbene derivative, a benzidine derivative, a diallylmethane derivative, a triallylmethane derivative, a 9-styryl anthracene derivative, a pyrazoline derivative, a divinylbenzene derivative, a hydrazone derivative, an indene derivative, a butadiene derivative, a pyrene derivative, a bisstilbene derivative, and/or an enamine derivative. One of the above-described substances or a mixture of two or more of the above-described substances can be used.

Examples of the binder resin include thermoplastic resins and/or thermosetting resins (e.g., polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, a polyarylate resin, a phenoxy resin, polycarbonate, a cellulose acetate resin, an ethyl cellulose resin, polyvinyl butyral, polyvinyl formal, polyvinyl toluene, poly-N-vinyl carbazole, an acrylic resin, a silicon resin, an epoxy resin, a melamine resin, an urethane resin, a phenol resin, and/or an alkyd resin).

The amount of the charge transport substance ranges from about 20 parts by weight to about 300 parts by weight, and preferably ranges from about 40 parts by weight to about 150 parts by weight, with respect to the binder resin of about 100 parts by weight. The charge transport layer 213 preferably has a thickness of not greater than about 25 μm in view of resolution and response and not smaller than about 5 μm. However, the lower limit of the thickness of the charge transport layer 213 may vary depending on a system used (e.g., a charge potential).

Examples of the solvent include tetrahydrofuran, dioxane, toluene, dichloromethane, monochloro benzene, dichloroethane, cyclohexanone, methyl ethyl ketone, and/or acetone. One of the above-described substances or a mixture of two or more of the above-described substances can be used.

The photosensitive layer as a single layer is produced by dissolving or dispersing the charge generating substance, the charge transport substance, the binder resin, and the like in a proper solvent, applying the dispersed solvent on a surface of the conductive support 210 or the insulating layer 211, and drying the applied solvent. The photosensitive layer may not include the charge transport substance. A plasticizer, a leveling agent, an antioxidant, and/or the like may be added as needed.

The photosensitive layer may include the binder resin used for the charge generating layer 212 in addition to the binder resin used for the charge transport layer 213. The photosensitive layer may include the above-described high polymer charge transport substances. The amount of the charge generating substance preferably ranges from about 5 parts by weight to about 40 parts by weight with respect to the binder resin of about 100 parts by weight. The amount of the charge transport substance preferably ranges from about 0 parts by weight to about 190 parts by weight and more preferably ranges from about 50 parts by weight to about 150 parts by weight with respect to the binder resin of about 100 parts by weight.

The photosensitive layer as a single layer may be produced by dispersing the charge generating substance, the binder resin, and the charge transport substance in a solvent including tetrahydrofuran, dioxane, dichloroethane, and/or cyclohexane with a dispersing machine or the like, and applying the dispersed liquid by soaking, spray-coating, bead-coating, and/or ring-coating. The photosensitive layer has a thickness of from about 5 μm to about 25 μm.

The insulating layer 211 may be formed between the conductive support 210 and the photosensitive layer. The insulating layer 211 generally includes a resin as a main ingredient. Since a solvent is applied on the resin to form the photosensitive layer, the resin is preferably a solvent-resistant resin which is resistant to general, organic solvents. Examples of the resin include water-soluble resins (e.g., polyvinyl alcohol, casein, sodium polyacrylate, and/or the like), alcohol-soluble resins (e.g., copolymer nylon, methoxy methylated nylon, and/or the like), cured resins having a three-dimensional network (e.g., polyurethane, a melamine resin, a phenolic resin, an alkyd-melamine resin, an epoxy resin, and/or the like).

The insulating layer 211 may include a fine powder pigment of metal oxides (e.g., titanium oxide, silica, alumina, zirconium oxide, tin oxide, indium oxide, and/or the like) to prevent moiré or to reduce residual potential.

The insulating layer 211 is produced by using a proper solvent and a proper applying method as described above for the photosensitive layer. The insulating layer 211 may include a silane coupling agent, a titanium coupling agent, and/or a chrome coupling agent. Further, the insulating layer 211 may include Al₂O₃ prepared by anodic oxidation, and/or an organic material (e.g., polyparaxylylene (parylene) and/or the like) and an inorganic material (e.g., SiO₂, SnO₂, TiO₂, ITO, CeO₂, and/or the like) prepared by a vacuum thin film producing method. The insulating layer 211 may include other known materials. The insulating layer 211 has a thickness of from about 0 μm to about 5 μm.

The surface layer 214 includes a material in which a powdery dispersant (e.g., alumina, tin oxide, and/or the like) is dispersed in a main ingredient (e.g., amorphous silicon, and/or the like). The surface layer 214 including the dispersant can provide an improved endurance.

The following describes another example of the photoconductor 2Y including the surface layer 214 including a cross-linked high polymer material. The cross-linked high polymer material is produced by causing cross-linking reaction with light or thermal energy by using a reactive monomer having a plurality of cross-linked functional groups in one molecule, for example. The cross-linked high polymer material has a three-dimensional network, providing an improved wear resistance. The reactive monomer wholly or partially including a monomer having a charge transport function can be effectively used to provide an improved electric stability, plate life, and life. When the monomer having the charge transport function is used, a charge transport portion is formed in the three-dimensional network, providing a further improved wear resistance.

Examples of the reactive monomer having the charge transport function include a compound including at least one charge transport component and at least one silicon atom having a hydrolysable substituent in one common molecule, a compound including a charge transport component and a hydroxyl group in one common molecule, a compound including a charge transport component and a carboxyl group in one common molecule, a compound including a charge transport component and an epoxy group in one common molecule, and/or a compound including a charge transport component and an isocyanate group in one common molecule. One of the above-described compounds or a mixture of two or more of the above-described compounds can be used.

Examples of the reactive monomer having the charge transport function preferably further include a reactive monomer having a triarylamine structure, which can provide an improved electric and chemical stability and an increased moving speed of carriers. A polymerized monomer and a polymerized oligomer, which have one or two functional groups, can be used together to provide an adjusted viscosity when applying the reactive monomer to the photoconductor 2Y, a decreased stress applied by the cross-linked charge transport layer 213, a decreased surface energy, and a decreased friction coefficient. Known polymerized monomers and polymerized oligomers can be used.

The cross-linked high polymer material is produced by polymerizing or cross-linking a hole transport compound by using thermal energy or light energy. When polymerizing the hole transport compound by using thermal energy, a polymerization reaction can be performed with thermal energy only or with thermal energy and an polymerization initiator. To effectively perform the polymerization reaction at a low temperature, the polymerization initiator is preferably added. When polymerizing the hole transport compound by using light energy, ultraviolet light is preferably used. However, a polymerization reaction is rarely performed with light energy only. Thus, a light polymerization initiator is generally added. The light polymerization initiator produces active species (e.g., radical, ion, and/or the like) by absorbing ultraviolet light having a wavelength of not greater than about 400 nm so as to start a polymerization reaction. A polymerization reaction can be performed with thermal energy and the light polymerization initiator.

The following describes an exemplary method for manufacturing the photoconductor 2Y including the surface layer 214 including a cross-linked high polymer material. Methyl trimethoxy silane of about 182 parts, dihydroxy methyl triphenylamine of about 40 parts, 2-propanol of about 225 parts, 2-percent acetate of about 106 parts, and aluminum trisacetyl acetonate of about 1 part are mixed to prepare an applying liquid for forming the surface layer 214. The applying liquid is applied onto the cross-linked charge transport layer. The applying liquid is dried and heat-hardened at about 110 degrees centigrade for about an hour. Thus, the surface layer 214 having a thickness of about 3 μm is formed.

The following describes another exemplary method for manufacturing the photoconductor 2Y including the surface layer 214 including a cross-linked high polymer material. A hole transport compound (shown in a structural formula 1 below) of about 30 parts by weight, and an acryl monomer (shown in a structural formula 2 below) and a light polymerization initiator (e.g., 1-hydroxy-cyclohexyl-phenyl-ketone) of about 0.6 parts are dissolved in a mixed solvent including monochlorobenzene of about 50 parts by weight and dichloromethane of about 50 parts by weight to prepare an applying liquid for forming the surface layer 214. The applying liquid for forming the surface layer 214 is applied onto the charge transport layer 213 by spray-coating, and is hardened at a light intensity of about 500 mW/cm² for about 30 seconds with a metal halide lamp. Thus, the surface layer 214 having a thickness of about 5 μm is formed.

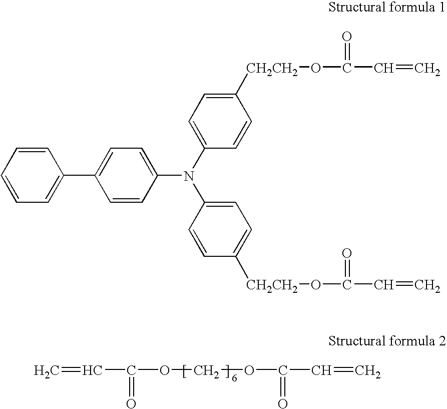

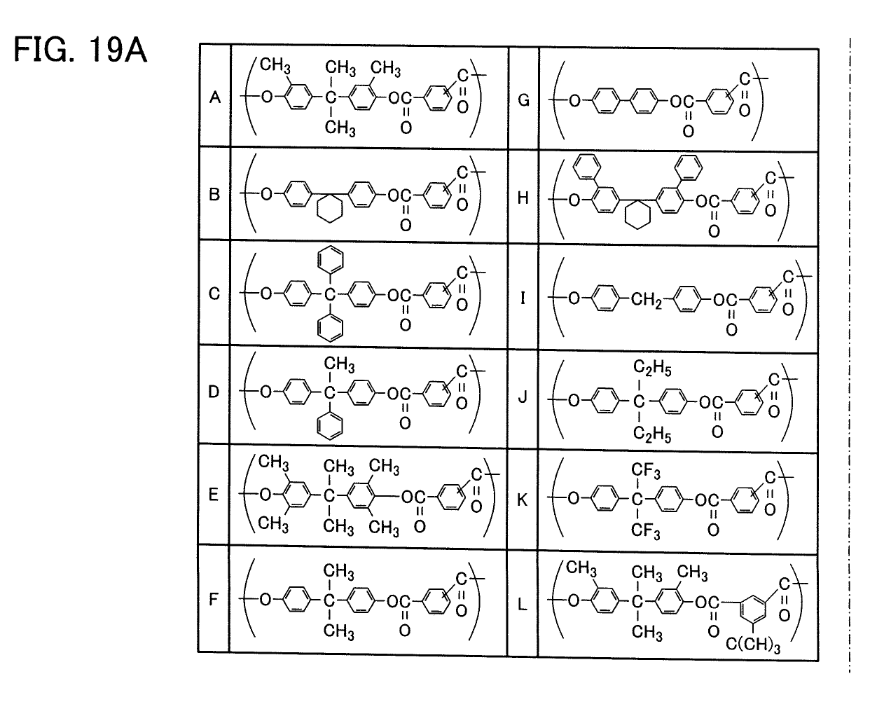

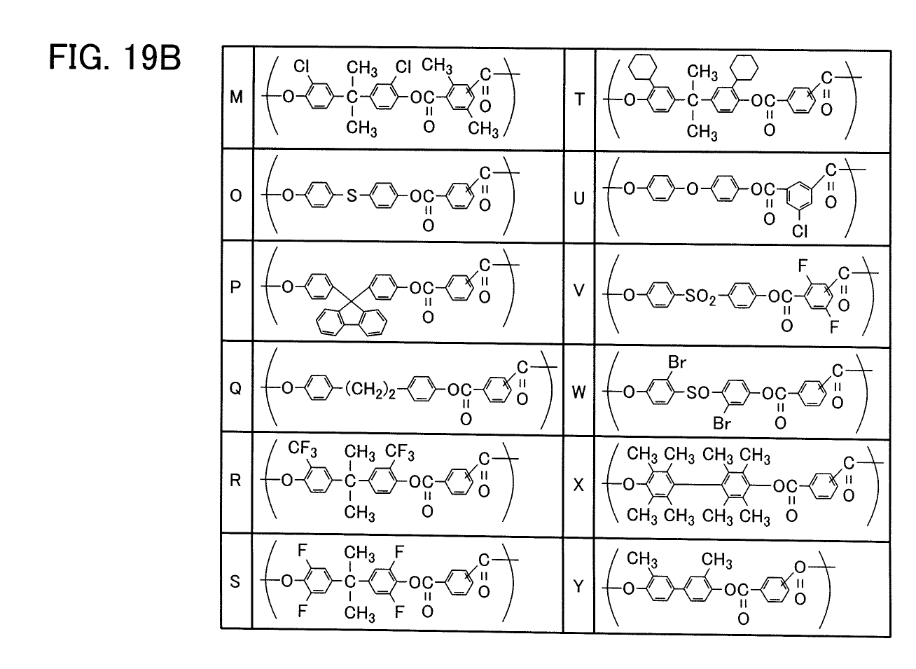

The following describes yet another example of the photoconductor 2Y including the surface layer 214 including a polyarylate resin or a material including the polyarylate resin as a main ingredient. Examples of the polyarylate resin have structural formulas A to L illustrated in FIG. 19A and structural formulas M and O to Y illustrated in FIG. 19B. The surface layer 214 including the polyarylate resin can provide an improved wear resistance.

In the printers (i.e., the image forming apparatuses 10, 10a, 10b, 10c, 10d, 10e, and 10f depicted in FIGS. 1, 10, 11, 12, 13, 14, and 15, respectively) according to the above-described non-limiting exemplary embodiments, the fine particle supplier (i.e., the development unit 6Y depicted in FIG. 2 or the development unit 6Ya, 6Ca, 6Ma, or 6Ka depicted in FIG. 10) supplies fine particles (i.e., toner particles) to the surface of the image carrier (i.e., the photoconductor 2Y, 2C, 2M, or 2K depicted in FIG. 1 or the photoconductor 2a depicted in FIG. 10) in the corona product removal mode while an image forming operation is not being performed. The electrostatic cleaning mechanism (i.e., the first cleaning brush 102Y, the second cleaning brush 112Y, the first collecting roller 105Y, the second collecting roller 115Y, the first roller power source 101Y, and the second roller power source 111Y depicted in FIG. 3, the first brush power source 107Y and the second brush power source 117Y depicted in FIG. 12, and the cleaning brush 122Y, the collecting roller 125Y, and the roller power source 121Y depicted in FIG. 13) electrostatically removes the toner particles supplied on the surface of the image carrier from the surface of the image carrier. The corona product removal mode is performed while an image forming operation is not being performed. Thus, the fine particle supplier can supply the toner particles onto the whole surface of the image carrier regardless of image data. Namely, a corona product is adhered to the toner particles on the whole surface of the image carrier. The electrostatic cleaning mechanism removes the toner particles to which the corona product is adhered so as to remove the corona product from the whole surface of the image carrier.

In the cleaners (i.e., the cleaners 10Y, 100a, 100Yc, 100Yd, 100Ye, and 100Yf depicted in FIGS. 3, 10, 12, 13, 14, and 15, respectively), an electric charge carried by the first nap 103Y (depicted in FIG. 3), the second nap 113Y (depicted in FIG. 3), and the nap 123Y (depicted in FIG. 13) electrostatically remove the toner particles. Thus, the toner particles to which the corona product is adhered can be properly removed from the whole surface of the image carrier.

The electrostatic cleaning mechanism includes a plurality of cleaning members (i.e., the first cleaning brush 102Y depicted in FIG. 3 for carrying electric charge having a positive polarity and the second cleaning brush 112Y depicted in FIG. 3 for carrying electric charge having a negative polarity). Namely, the first cleaning brush 102Y removes negatively charged toner particles. The second cleaning brush 112Y removes positively charged toner particles. Thus, even when negatively charged toner particles and positively charged toner particles are mixed on the surface of the image carrier, the mixed toner particles can be properly removed.

When toner particles have a small particle size (e.g., an average particle size of not greater than about 5.0 μm), the amount of removed corona product can increase with respect to the amount of toner particles supplied onto the surface of the image carrier.

Toner particles supplied by the fine particle supplier are used as fine particles for attracting a corona product. Thus, the corona product can be removed from the surface of the image carrier with no extra device for removing the corona product added to the printer.

The process unit (i.e., the process unit 201Y depicted in FIG. 11) integrally supports at least the image carrier and the cleaner. The process unit is attachable to and detachable from the printer. Thus, the printer can provide an easier maintenance performed by a user.

The charger (i.e., the charging roller 4Y depicted in FIG. 2 or the charging roller 4a depicted in FIG. 10) is turned off while the corona product removal mode is on. Thus, new corona product is not generated while the cleaner removes the corona product from the surface of the image carrier, resulting in an effective removal of the corona product.

Toner particles having the shape factor SF-1 of from about 100 to about 150 are used to form a toner image on the surface of the image carrier. Thus, the toner particles forming the toner image are easily transferred from the image carrier onto the intermediate transfer belt 21 (depicted in FIG. 1) or the intermediate transfer belt 21a (depicted in FIG. 10). The cleaner can remove a smaller amount of toner particles from the surface of the image carrier, resulting in formation of a high quality image and a longer life of the cleaner.

The image carrier includes the surface layer (i.e., the photoconductive layer 202b depicted in FIG. 17A, the surface layer 202c depicted in FIGS. 17B, 17C, and 17D, or the surface layer 214 depicted in FIG. 18). The surface layer includes amorphous silicon, the material in which the powdery dispersant is dispersed in the main ingredient, the cross-linked high polymer material, the polyarylate resin, or the material including the polyarylate resin as the main ingredient. Thus, the surface of the image carrier does not have a concavo-convex shape, preventing or reducing a decreased cleaning performance. Even in the corona product removal mode, the cleaner can provide a proper cleaning performance.

As illustrated in FIG. 13, the cleaner 100Yd includes the cleaning brush 122Y and the polarity controller (i.e., the polarity control brush 128Y). As illustrated in FIG. 14, the cleaner 100Ye includes the cleaning brush 122Y and the polarity controller (i.e., the polarity control blade 129Y). The polarity controller controls toner particles on the surface of the image carrier to have a negative polarity. The cleaning brush 122Y carries an electric charge having a positive polarity. Specifically, the polarity controller causes positively charged toner particles on the surface of the image carrier to have a negative polarity. Consequently, the toner particles on the surface of the image carrier have a negative polarity. The cleaning brush 122Y removes the negatively charged toner particles from the surface of the image carrier. Thus, even when negatively charged toner particles and positively charged toner particles are mixed on the surface of the image carrier, the cleaners 100Yd and 100Ye can properly clean the surface of the image carrier.

The present invention has been described above with reference to specific exemplary embodiments. Note that the present invention is not limited to the details of the embodiments described above, but various modifications and enhancements are possible without departing from the spirit and scope of the invention. It is therefore to be understood that the present invention may be practiced otherwise than as specifically described herein. For example, elements and/or features of different illustrative exemplary embodiments may be combined with each other and/or substituted for each other within the scope of the present invention.

What is claimed is:

1. An image forming apparatus, comprising:
an image carrier;
a charger configured to charge a surface of the image carrier;
an electrostatic latent image forming member configured to form an electrostatic latent image on the charged surface of the image carrier;
a developing member configured to develop the electrostatic latent image formed on the surface of the image carrier with toner particles to form a toner image;
a transferor configured to transfer the toner image formed on the surface of the image carrier onto a recording medium; and
a cleaning device configured to remove a foreign substance from the surface of the image carrier and including,
a fine particle supplier configured to supply fine particles onto the surface of the image carrier while an image forming operation is not being performed, and
an electrostatic cleaning mechanism configured to electrostatically remove the foreign substance adhered to the supplied fine particles from the surface of the image carrier.

2. The image forming apparatus according to claim 1, wherein the transferor includes a transfer member configured to carry the toner image, transferred from the surface of the image carrier, to be further transferred onto the recording medium.

3. The image forming apparatus according to claim 1, wherein the electrostatic cleaning mechanism includes,
a first cleaning member configured to contact the surface of the image carrier and to carry an electric charge having a positive polarity, and
a second cleaning member configured to contact the surface of the image carrier and to carry an electric charge having a negative polarity.

4. The image forming apparatus according to claim 1, wherein the electrostatic cleaning mechanism includes,
a first cleaning member positioned close to the surface of the image carrier and configured to carry an electric charge having a positive polarity, and
a second cleaning member positioned close to the surface of the image carrier and configured to carry an electric charge having a negative polarity.

5. The image forming apparatus according to claim 1, wherein the electrostatic cleaning mechanism includes,
a cleaning member configured to contact the surface of the image carrier, and
a polarity controller disposed upstream from the cleaning member in a rotating direction of the image carrier and configured to control the fine particles supplied onto the surface of the image carrier to have a common polarity, and
wherein the cleaning member carries an electric charge having a polarity opposite to the polarity of the fine particles.

6. The image forming apparatus according to claim 1, wherein the electrostatic cleaning mechanism includes,
a cleaning member positioned close to the surface of the image carrier, and
a polarity controller disposed upstream from the cleaning member in a rotating direction of the image carrier and configured to control the fine particles supplied onto the surface of the image carrier to have a common polarity, and
wherein the cleaning member carries an electric charge having a polarity opposite to the polarity of the fine particles.

7. The image forming apparatus according to claim 1, wherein the fine particles have an average particle size of no greater than about 5.0 μm.

8. The image forming apparatus according to claim 1, wherein the fine particles include toner particles.

9. The image forming apparatus according to claim 1, wherein the charger does not charge the surface of the image carrier when the fine particle supplier supplies the fine particles onto the surface of the image carrier while an image forming operation is not being performed.

10. The image forming apparatus according to claim 1, wherein the fine particles include toner particles supplied by the developing member.

11. The image forming apparatus according to claim 1, wherein the toner particles have a shape factor SF-1 of from about 100 to about 150.

12. The image forming apparatus according to claim 1, wherein the image carrier includes a surface layer including amorphous silicon.

13. The image forming apparatus according to claim 1, wherein the image carrier includes a surface layer including a material in which a powdery dispersant is dispersed in a main ingredient.

14. The image forming apparatus according to claim 1, wherein the image carrier includes a surface layer including a cross-linked high polymer material.

15. The image forming apparatus according to claim 1, wherein the image carrier includes a surface layer including any one of a polyarylate resin and a material including the polyarylate resin as a main ingredient.

16. The image forming apparatus according to claim 1, further comprising:
a process unit, including the image carrier and the cleaning device, configured to attach to and detach from the image forming apparatus, the process unit further including a support configured to support the image carrier and the cleaning device.

17. A process unit, comprising:
an image carrier;
a cleaning device configured to remove a foreign substance from a surface of the image carrier and including,
a fine particle supplier configured to supply fine particles onto the surface of the image carrier while an image forming operation is not being performed, and
an electrostatic cleaning mechanism configured to electrostatically remove the foreign substance adhered to the supplied fine particles from the surface of the image carrier; and
a support configured to support the image carrier and the cleaning device.

18. A cleaning device for removing a foreign substance from a surface of an image carrier, comprising:
a fine particle supplier configured to supply fine particles onto the surface of the image carrier while an image forming operation is not being performed; and
an electrostatic cleaning mechanism configured to electrostatically remove the foreign substance, adhered to the supplied fine particles, from the surface of the image carrier.
